(19) United States
(12) Patent Application Publication
(10) Pub. No.: US 2025/0265545 A1
(43) Pub. Date: Aug. 21, 2025

(54) METHOD AND SYSTEM FOR ENABLING TRUSTWORTHY ARTIFICIAL INTELLIGENCE SYSTEMS THROUGH TRANSPARENT MODEL ANALYSIS

(71) Applicant: ObjectSecurity LLC

(72) Inventors: Jason KRAMER, Studio City, CA (US); Ulrich LANG, San Diego, CA (US); Stephen BRENNAN, San Diego, CA (US); Reaz FATAHI, Encino, CA (US)

(73) Assignee: ObjectSecurity LLC, (US)

(21) Appl. No.: 19/058,884

(22) Filed: Feb. 20, 2025

Related U.S. Application Data
(60) Provisional application No. 63/555,869, filed on Feb. 20, 2024.

(51) Int. Cl. G06Q 10/087

(52) U.S. Cl. CPC G06Q 10/087

(57) ABSTRACT

Method and system for analyzing at least one computing system for supply chain vulnerabilities of at least one machine learning model include configuring machine learning model and optionally additional data; decomposing operations of the machine learning model's computational graph into smaller decomposed components; associating properties of each decomposed component with properties of the original operations and associating additional data; detecting the semantic similarity of decomposed component and previously encountered decomposed components; converting decomposed components into a standardized representation; calculating signature of decomposed components; evaluating whether portions of the machine learning model are similar to previously calculated signature; testing for supply chain and model vulnerabilities that exist based on previous signatures; identifying vulnerabilities that persist and correlating defenses; storing the generated signatures, identified vulnerabilities, and identified defenses; and generating report detailing the machine learning model's supply chain, vulnerabilities, and defenses.

This application claims priority to U.S. Provisional Application Nos. 63/555,869 entitled “Method and System for AI/ML Bill of Materials and Tactical Reinforcement Understanding with Symbolic Translation, which was filed on Feb. 20, 2024, and which is incorporated herein by reference.

### BACKGROUND OF THE INVENTION

### 1. Field of the Invention

This application relates generally, but not exclusively, to a novel method relating to analyzing computing systems, including, but not limited to, those including artificial intelligence (AI). More specifically, embodiments of the invention are directed at automatically and semi-automatically detecting, analyzing, and mitigating weaknesses, vulnerabilities, and risks in an AI model and its dependencies, including its lineage of versions and models. It may aim to improve the model and its dependencies' accuracy, efficiency, robustness, etc.

### 2. Description of the Related Art

### AI/ML Adversarial Attacks

The recent rapid advancement and adoption of Artificial Intelligence (AI) has enabled a multitude of opportunities for innovative solutions to solve complex challenges. However, AI systems are often opaque, making it difficult to understand their inner workings and behavior. This lack of transparency creates a significant gap in credibility and trust required for the widespread adoption of AI.

To fully trust the results of an AI system, operators need insights into how it was trained, including data, model, and potential risks. They require understanding of decision-making processes during inference, and awareness of external threats or limitations that may negatively impact performance.

Training large-scale AI models requires substantial datasets and computational resources. Industry-wide movements towards labeled dataset reuse and transfer learning can save organizations resources by reusing existing data or leveraging partial or full open-source datasets that fit their desired objectives. Transfer learning, a technique to reuse and fine-tune a pre-trained model for a new task, is commonly utilized to avoid training completely new models, saving significant computing power and time.

As a result of the inherent complexity and size of AI models, there are many gaps in operators being able to understand all decisions and data that went into the training and fine-tuning processes. Furthermore, the widespread reuse of datasets and transfer learning has created new challenges in ensuring trust between an operator and an AI system. Providing a transparent view into potential risks and vulnerabilities is crucial to creating trust and preventing adversarial attacks.

Conventional techniques exist detailing ways to attack models, including poisoning attacks, gradient-based attacks, token manipulation, jailbreak prompting, red-teaming, model inversion, etc. By using such techniques, attackers can negatively impact an AI system's performance and decision-making, triggering specific behaviors and outputs. Therefore, explainability of a model's behavior and risks is paramount to creating trust and preventing harm from AI systems.

Open-source models, such as those available on Hugging Face, can be fine-tuned using transfer learning for specific target domains. This provides machine learning engineers with the flexibility to utilize advanced models without having to train new ones from scratch. However, this also brings forth the need to carefully evaluate the risks and limitations associated with these pre-trained models. Overall, ensuring trust between an operator and an AI system requires a comprehensive approach that addresses transparency, explainability, and vulnerability assessment.

### Poisoning Attacks

A poisoning attack is a specific type of adversarial attack that occurs when a model's training data, data preparation pipeline, or architecture is intentionally tampered with, with the objective of making incorrect or harmful decisions. A successful poisoning attack may result in the full model making poor decisions or only making poor decisions for targeted inputs. There are many different types of poisoning attacks, such as label poisoning where malicious data or labels are injected into a training dataset to influence the model during inference, stealth poisoning attempts to create vulnerabilities in the model that are difficult to detect during development, targeted attacks that aim to compromise a subset of data, and others. Poisoning attacks can be dangerous because they are very difficult to detect, since an attacker may only need to put a small amount of noise over training data in order to corrupt it. Detection would also require access to the training data, which may be unavailable in the case of transfer learning from an open-source model, or the datasets may be available but very large (e.g., billions or trillions of tokens), which would be costly to analyze. Even if a dataset's integrity is validated, it has also been proven that a model, or even if its artifact, can be tampered with by injecting malicious code into the model's code in order to poison it. Poisoning attacks have even been proven to affect unsupervised learning by attacking the learning objective and cause it to become a poor feature extractor.

### Backdoor Attacks

Backdoor attacks are a specific type of poisoning attack, wherein a backdoor, or Trojan, is embedded into a model to manipulate its behavior during inference only on inputs that include the backdoor's trigger. For example, an attacker can add a backdoor to a LLM to influence the outputs when specific inputs are provided, resulting in misinformation being provided to the operator or posing security risks. Backdoor attacks are especially dangerous because the model may be trained and tested with high performance, and exhibit no signs of an adversarial attack, until it is presented with the backdoor's trigger. An attacker may control or influence the model during inference, or they may predict how operators will use the model and target specific data they believe the model will receive. This could result in potentially catastrophic consequences, such as data breaches of critical data, or even life-threatening situations if used in mission-critical applications. Similar to poisoning attacks, there is an assortment of research that has been published documenting the many ways in which a backdoor attack can be carried out. Finally, backdoor attacks have been proven to work on multimodal AI models, such as by injecting backdoors by tampering with image synthesis in diverse semantic levels.

### Attack Transferability

The rapid adoption of transfer learning to save resources and improve model performance has also increased the risk of attack transferability, where an attack on a pre-trained model can persist to the fine-tuned model. Conventional approaches have proven that a fine-tuned model can still be affected by a poisoning attack that was present in a pre-trained model, even if the data they are using for fine-tuning does not contain any malicious data. For example, latent backdoors are incomplete backdoors that are injected into a pre-trained or fine-tuned model, and can be generalized to a label's index, and they only become complete and can be triggered after transfer learning, making them more dangerous and very difficult to detect. They prove that attacks that persist through transfer learning can also target and be embedded into specific layers of a model, such as earlier layers that are more likely to be frozen during fine-tuning or layers that have the highest impact on the final inference output.

### Explainable AI for Reinforcement Learning

In complex and critical domains, the limitations of Reinforcement Learning (RL) have become increasingly apparent. The opaque nature of decision-making processes in RL systems hinders their ability to provide transparency and accountability in high-stakes environments. Precision, adaptability, and explainability are crucial for success in these settings, where human oversight and control are essential. The need for Explainable Reinforcement Learning (XRL) solutions grows out of this necessity. By developing RL solutions that are interpretable, accountable, and controlled, we can enhance the trustworthiness and reliability of AI systems in critical applications. This shift in focus emphasizes the importance of creating RL models that prioritize transparency, explainability, and auditability. The limitations of traditional RL systems highlight the need for more comprehensive approaches to developing explainable AI solutions.

In the contemporary landscape, the logistical demands for RL and XRL systems are increasingly becoming necessary due to their potential to enhance decision-making processes across various sectors. However, the potential risks and areas for improvement in RL systems are a topic of ongoing discussion in the Artificial Intelligence and Machine Learning (AI/ML) community. Without the support of more reliable, transparent, and interpretable RL systems, blind changes to live production environments are unimaginable in many or most mission-critical scenarios.

Various public and private sectors are affected by this, including healthcare, finance, transportation, logistics, manufacturing, energy, and others. In healthcare, RL is intended to optimize tasks such as patient diagnosis and treatment planning. The financial sector can utilize RL for optimizations to risk assessment and algorithmic trading. Autonomous vehicles are reliant on RL for navigation and safety and have seen incidents where systems failed to respond adequately, leading to safety concerns. RL also enhances operations in areas such as predictive maintenance, mission planning, demand forecasting, and energy distribution. These and other domains have seen a surge in AI/ML use for decision-making support and their demand for RLs is growing for its promise to provide more layers of AI/ML optimization and to improve operational accuracy and efficiency.

The increasing logistical demand for XRL arises from the shortcomings of modern RL systems for ensuring safety, reliability, and explanations of its decisions, requiring solutions to address reward misalignment, model robustness, and decision-making transparency. By overcoming these challenges, in light of emerging regulatory compliance needs and the current state of technological limitations, XRL has the potential to impact global industries.

Conventional RL systems are limited in several facets. Firstly, a fundamental limitation is the absence of interpretable or explainable decisions made by current RL systems. Contemporary systems lack understandable explanations for their decisions that can be verified manually or through other layers of checks within automation.

Another limitation is that while theoretically appealing, existing approaches face practical challenges due to performance limitations. Approaches like Layerwise Relevance Propagation (LRP) provide insights into neural network decisions by visualizing the contribution of each neuron to the final decision. While these techniques are useful during development and post-hoc investigations of failures, they are insufficient for complex real-time environments.

The trade-off between the depth of explanation and the practical performance of RL systems in real-time decision-making environments is a critical concern. Contemporary theories and approaches in XRL necessitate a choice between the depth, operational efficiency, and utility of outcomes. Recently, symbolic AI has garnered attention for its capacity to facilitate abstract reasoning that surpasses statistical AI approaches alone. Symbolic AI experiments have repeatedly demonstrated their strengths in representing complex reasoning processes through logical rules and symbols, potentially making the inner workings of AI systems more accessible to human operators. The observability data from an instrumented RL system can be mapped to a reduced set of logical operators, resulting in a reduction of the space complexity of outputs into a more intuitive explanatory form. The potential ability to acquire transparency from RL systems can result in a critical transformation of these systems that can be accessed conveniently, fulfilling a critical necessity for their deployment in environments where decisions can have far-reaching consequences.

### Symbolic Analysis for Reinforcement Learning

In logical programming, especially within the context of symbolic AI and symbolic analysis, it is possible to create logical expressions that represent the internal processes such as vector manipulations, weight adjustments, and activation flows encountered in RL system. This approach involves abstracting the operations and behaviors of the system into a form that can be analyzed or reasoned about symbolically.

Rule-based Explanations and Inductive Logic Programming (ILP) are emerging as techniques in Explainable Artificial Intelligence (XAI). Research in Deep Explainable Relational Reinforcement Learning (DERRL) aims to leverage the interpretability and relational structure of ILP in deep RL systems. It is a neuro-symbolic approach to learn the decision-making rules and policies of an RL agent arriving at its decision in human-understandable terms. Yet, there is a critical gap in acquiring the context, state, and dynamic environments of RL systems.

The concept of a digital twin addresses these challenges by providing a real-time, virtual replica of the RL system, allowing for instrumentation, and monitoring of the RL agent's interactions, states, and changes. This approach also considers environmental analysis, which is largely absent in current XRL solutions. Most importantly, the integration of symbolic AI with deep RL digital twins results in neuro-symbolic architectures that combine strengths in abstract reasoning capabilities with adaptive learning and real-time self-modification, without the need for retraining or manual updates.

### Digital Twins for Reinforcement Learning

Surrogate modeling is a mature technique in evaluating AI/ML systems, widely recognized for its ability to approximate complex models and provide insights into their functioning. However, surrogate modeling alone is insufficient for capturing and explaining the dynamic and sequential decision-making processes of RL systems. Surrogate models are static snapshots that fail to consider the temporal adaptations from reward mechanisms of RL systems. Therefore, it is not feasible for this technique to generalize various RL systems. This is where digital twins become essential in their ability to simulate dynamic and interactive systems.

Indeed, support for this observation is established by prior works that report on the applicability and benefits of digital twins to simulate complex systems in real-time. This and related works establish the basis to pursue this track for extending the current limitations of surrogate modeling systems to apply to complex RL systems. More recently, digital twins have been utilized in RL to simulate training environments. However, there are very few resources available about the use of digital twins to analyze AI/ML systems including RL.

### SUMMARY OF THE INVENTION

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. For example, singular or plural use of terms are illustrative only and may include zero, one, or multiple; the use of “may” signifies options; modules, steps and stages can be reordered, present/absent, single or multiple etc.
An objective of the invention is to build trust between an AI model and operators who are utilizing its outputs, by demystifying complex models and their dependencies that were previously opaque.
It may determine that a model is not fit for use (e.g., for low performance, risks of an inference-based attack, risks of a backdoor, etc.) and provide suggestions on how the model can be remedied in order for it to be safe for deployment.
It may track versions of dependencies used in a model, stores information about the model and adversarial tests ran against it and communicates risks in the model's dependencies.
It may track the versions and lineage of an AI model and its other AI artifacts.
It may instrument AI compilers and analyze compiled AI models.
It may suggest use cases from an AI artifact and it may suggest models based on a use case.
It may detect vulnerabilities and risks in AI artifacts, such as poisoned attacks, evasion attacks, backdoor attacks, etc.
By converting the RL decision-making processes into symbolic representations, the analysis system may offer a more human-readable and understandable format
It may demystify the complex operations within the neural networks of RL agents, making their actions and decisions available for articulation, reporting, and automations.
It may leverage layer-wise technologies to enable ingress and decomposition of reference models representing RL agents and their instrumentation for enhanced observability. The layer-wise approach may allow configurable instrumentation on a layer-by-layer basis according to the needs of various environments.
It may support the integration of hardware and software optimizations, including FPGAs/SoCs and quantization approaches, respectively. This synergy may enhance operations in diverse contexts, including edge devices, command facilities, and research laboratories.
The intermediate representation's compatibility with a wide range of RL systems may ensure adaptability to both open- and closed-source models. The mechanism may be compatible with the dynamic changes to RL decision-making outcomes.
The combination of a digital twin and symbolic AI may enable real-time monitoring and analysis of the RL system's functionality.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1. depicts a high-level example of an analysis system

FIG. 2. depicts an analysis system used to analyze AI artifact supply chains

FIG. 3. depicts an example of a model database system

FIG. 4. depicts a process to obtain models and populate a model database system

FIG. 5. depicts an example of model version control

FIG. 6. depicts an example of model similarity and attack transferability

FIG. 7. depicts an example of vulnerability and explainability analysis

FIG. 8. depicts an example of automated vector generation

FIG. 9. depicts an example of model vulnerability scanning

FIG. 10. depicts an example of AI compiler instrumentation

FIG. 11. depicts an example of reverse engineering AI models for analysis

FIG. 12. depicts an example of dataset signature generation

FIG. 13. depicts an example of an analysis system in an AIOps pipeline

FIG. 14. depicts an example of use case identification

FIG. 15. depicts an example of identifying optimal models based on input

FIG. 16. depicts an example of migrating to another model

FIG. 17. depicts an example of an analysis system for reinforcement learning

FIG. 18. depicts an example of an analysis system for explainable reinforcement learning

FIG. 19. depicts an example of predicting model degradation

FIG. 20. depicts an example of an AI artifact marketplace UI/UX

FIG. 21. depicts an example of a model historical analysis UI/UX

FIG. 22. depicts an example of a training simulator visualization UI/UX

### DETAILED DESCRIPTION

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage, or mode of operation.

Further, many examples are described in terms of sequences of actions to be performed by, for example, elements of a computing device. It will be recognized that various actions described herein can be performed by specific circuits (e.g., Application Specific Integrated Circuits (ASICs), Field Programmable Gate Arrays (FPGA), Graphics Processing Units (GPU)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

### Terminology

For this specification, terms may be defined as follows:

Adversarial Attack—A malicious attempt which tries to perturb data to affect a model's predictions and (typically) evade detection.

Artificial Intelligence (AI) —development and application of algorithms, computational models, and computer systems that enable machines to simulate human-like cognitive processes, such as perception, reasoning, learning, and decision-making, through machine learning and data analysis techniques.

Artificial Intelligence (AI) Artifacts—May include, but is not limited to data used to train the system(s), data used to validate and/or test the system(s), continuous data provided for inference to the system(s), synthetic data generated by an Analysis System, AI model card(s), libraries and packages, manifest files, configuration files, repositories (e.g., Git, GitHub, GitLab, BitBucket, etc.), history of actors and actions (who have modified the model, its data, etc., and their actions, contact information, etc.), model names and versions, model configurations (e.g., model type, number of epochs, number of layers, number of neurons, model architecture, source(s) of original model, learning rate, batch size, etc.) links to sources of data, links to sources of model(s), preprocessing, deployment, maintenance, and monitoring pipelines (e.g., CI/CD, AIOps, MLOps, etc.), documentation (e.g., word documents, markdown files, PDFs, HTML, etc.), source code, compiled models, compilers, assemblers, disassembled files, intermediate representations, certifications (e.g., HIPAA, GDPR, etc.), compliance mappings, performance results (e.g., accuracy, recall, F1, precision, etc.), robustness results (e.g., CLEVER, distortion metrics, robustness curves, etc.), and/or explainability results (e.g., SHAP, LIME, etc.), etc.

Cross Lipschitz Extreme Value for nEtwork Robustness (CLEVER) —Score that may be used to measure the robustness of an AI model regarding adversarial attacks.

Information Technology (IT) —The use and application of computers, software, and other digital systems to manage, process, store, and communicate information in various fields.

Model Card—A document that goes with a model and/or dataset that provides information on how it was trained, validated, and/or tested, including its limitations, benefits, biases, and/or intended uses.

Operational Technology (OT) —Systems used to monitor and control physical devices and infrastructures, typically in an industrial setting.

The following sections describe examples corresponding to the figures presented in this patent.

### 1) Embodiment of the Analysis System

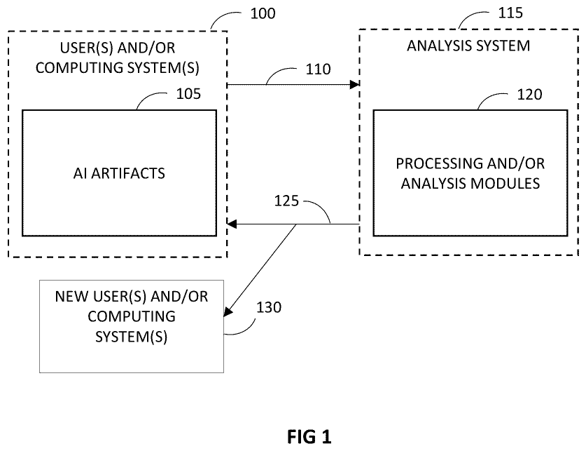

FIG. 1 depicts an example of an Analysis System 115, wherein a User(s) and/or Computing System(s) 100 may interact with and/or may configure an analysis of one or more AI Artifact(s) 105. For example, an Analysis System 115 may process and/or analyze one or more AI Artifacts 105 provided. AI Artifacts 105 may come from one or more computing systems.

1.1) User(s) and/or Computing System(s)

One or more User(s) and/or Computing System(s) 100 may provide and/or configure inputs. For example, User(s) and/or Computing System(s) 100 may include, but are not limited to, laptops, desktops, tablets, cloud computing, edge devices, fog devices, servers, transport systems, databases, database management systems, networks, space systems, weapons systems, and/or cellular devices, etc. These systems may contain one or more AI systems, and/or they may be on another system(s). Multiple devices being used as input may include, but is not limited to, IT and/or OT systems. Inputs may be provided via a network and/or storage. User(s) and/or Computing System(s) 100 may contain one or more AI Artifact(s) 105.

### 1.2) AI Artifacts

AI Artifacts 105 may include, but are not limited to data used to train the system(s), data used to validate and/or test the system(s), continuous data provided for inference to the system(s), synthetic data generated by an Analysis System 115, AI model card(s), libraries and packages, manifest files, configuration files, repositories (e.g., Git, GitHub, GitLab, BitBucket, etc.), history of actors and actions (who have modified the model, its data, etc., and their actions, contact information, etc.), model names and versions, model configurations (e.g., model type, number of epochs, number of layers, number of neurons, model architecture, source(s) of original model, learning rate, batch size, etc.) links to sources of data, links to sources of model(s), preprocessing, deployment, maintenance, and monitoring pipelines (e.g., CI/CD, AIOps, MLOps, etc.), documentation (e.g., word documents, markdown files, PDFs, HTML, etc.), source code, compiled models, compilers, assemblers, disassembled files, intermediate representations, certifications (e.g., HIPAA, GDPR, etc.), compliance mappings, performance results (e.g., accuracy, recall, F1, precision, etc.), robustness results (e.g., CLEVER, distortion metrics, robustness curves, etc.), and/or explainability results (e.g., SHAP, LIME, etc.), etc. These artifacts may be from one or more model(s). AI systems may include supervised learning, unsupervised learning, reinforcement learning, language models, classification models, computer vision, regression models, clustering models, generative models, autoencoder models, and/or transfer learning, etc. AI system data may be provided in formats, such as but not limited to, JSON, CSV, PNG, ZIP, JPEG, PDF, MP3, MP4, and/or TXT, etc. AI models may be provided in formats such as, but not limited to, TensorFlow, PyTorch, Keras, Transformers, TFLite, Caffe, Spark, scikit-learn, etc.

### 1.3) Input Mechanism

AI Artifacts 105 may be provided to and/or configured by an Analysis System 115 through one or more mechanisms 110. Data may be provided partially or in full. This may include, but is not limited to, through a graphical user interface (GUI), application programming interface (API), command line interface (CLI), through a storage device, protocols such as FTP, SSH, SCP, etc. Data may be provided all at once, sequentially, periodically, and/or contextually (e.g., as needed by an analysis system), etc. AI Artifacts 105 may be retrieved, such as but not limited to, scraping open-source and closed-source model repository, finding files in a file system, and/or utilizing an API, etc.

### 1.4) Analysis System

An Analysis System 115 may contain one or more Processing and/or Analysis Modules 120 that take in one or more AI Artifacts 105 and output one or more results. It may be on but is not limited to a single computing system.

### 1.5) Processing and Analysis of AI Artifacts

One or more Processing and/or Analysis Modules 120 may be used, for example, to process and/or analyze the data from one or more artificial intelligence (AI) systems, including but not limited to analyzing the supply chain of the AI system(s) (e.g., to determine dependencies, similar AI artifacts, vulnerabilities, explainability, performance, document models, map to regulations, etc.), instrument models, test and/or determine if models are vulnerable, analyze the software dependencies of the model, determine what data was used to train the model, determine what data was used to evaluate the model, determine other models that are viable (e.g., based on data, task, purpose, etc.), explain the decision-making of models, test the performance of models, store models, and/or store information about models, etc.

### 1.6) Output Mechanism

One or more Outputs 125 are then provided to one or more User(s) and/or Computing System(s) 100 and/or one or more New User(s) and/or Computing System(s) 130. The output may be the same or different. Output may be provided partially or in full. It may be provided through one or more mechanisms. Mechanisms may include, but are not limited to, a graphical user interface (GUI), application programming interface (API), command line interface (CLI), through a storage device, protocols such as FTP, SSH, SCP, etc. Data may be provided all at once, sequentially, periodically, and/or contextually (e.g., as needed by user(s) and/or system(s)), etc. Output may be in the form of a report that is printed, a light that changes to a color, a sound that plays, an email, a text, and/or a notification, etc.

### 2) Functional Diagram of Analysis System Analyzing AI Artifact Supply Chain

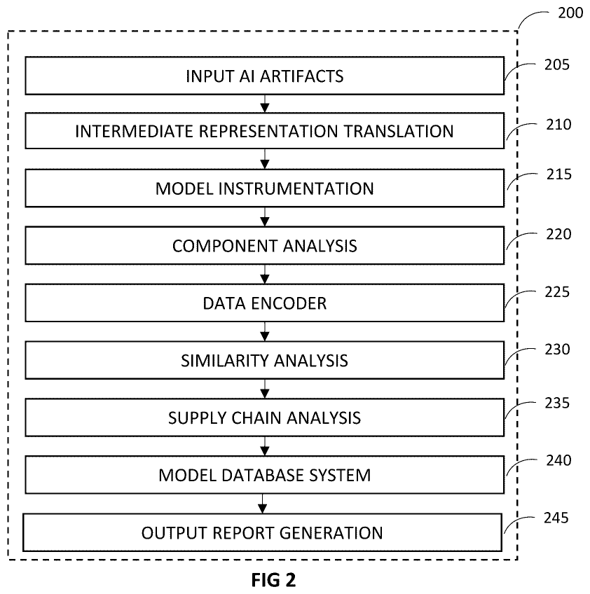

FIG. 2 depicts an example of an Analysis System 200 in the context of it being used to analyze the supply chain of one or more AI artifacts. This process may be reordered. It may include other steps not included in this figure and/or steps may be removed in other examples.

### 2.1) Analysis System

In this example, one or more Input AI Artifacts 205 are provided to an Analysis System 200, and output may include, but is not limited to, a report of the dependencies in the supply chain (e.g., models, architectures, data, libraries, etc.), a bill of materials, the most similar model(s), the most similar dataset(s), other viable model(s), a report detailing other AI Artifacts in a supply chain, and/or branches within a supply chain, etc.

### 2.2) Input AI Artifacts

Input AI Artifacts 205 for an example of an Analysis System 200 used to analyze supply chain(s) may include, but is not limited to, models, data, documentation, links (e.g., to libraries, repositories, documentation, and/or HuggingFace models and/or datasets, etc.), and/or existing bill of materials, etc. This data may be ingested by an Analysis System 200. It may be validated for accuracy and/or consistency. This may include checking that the dataset provided is applicable to the model and/or architecture provided. An Analysis System 200 may request additional required and/or optional Input AI Artifacts 205 and/or other additional information (e.g., whether or not to add the model into a database, the type of output(s), and/or the format of the output(s), etc.).

### 2.3) Intermediate Representation Translation

An Intermediate Representation Translation 210 module may adapt one or more Input AI Artifacts 205 into one or more formats. This may be done for consistency and/or compatibility. It may be used for open-source and/or closed-source models. It may include putting data into a standardized format, such as a pandas table or CSV. It may include processes for sanitizing data before and/or after providing it to one or more analysis. It may include decomposing AI models (e.g., breaking down AI models into smaller components), such as but not limited to, individual layers, neurons, layer modules, etc. It may include analyzing aspects of each smaller component to better understand how the model was trained. It may translate models into another representation, such as (but not limited to) translating a TensorFlow model to ONNX, an ONNX model to TensorFlow, and/or a PyTorch model to TensorFlow, etc. It may translate other Input AI Artifacts 205 into an intermediate representation, such as data transforms, and/or loss functions, etc. An Intermediate Representation Translation 210 module may translate an entire Input AI Artifact 205 into an intermediate representation, and/or it may only translate part of it. For example, if a model is being decomposed into individual layers, it may only translate every other layer, or every three layers. An Input AI Artifact 205 may already be in an intermediate representation and not need to be translated. It may perform automatic detection to, for example, figure out the type of AI model, the framework, data type(s), etc. It may determine whether Input AI Artifacts 205 are in a format that can be lifted to an intermediate representation. It may request additional information from a user and/or system. It may obtain information elsewhere, such as performing searches to find information about, for example, the AI model(s), architecture(s), author(s), dependencies, etc. This may be performed, for example, to put AI models into a format where gradients are accessible and/or are in a standardized format, etc. Intermediate representations may be validated, for example, by ensuring that the size of intermediate layer(s) are the same, the size of outputs are the same, and/or that accuracy remains the same or similar, etc. Intermediate representation(s) may be stored in an Analysis System 200. Intermediate representation day may be provided to a Model Instrumentation 215 module for further processing.

### 2.4) Model Instrumentation

This process may include a Model Instrumentation 215 module, wherein it may include instrumenting components to, for example, retrieve intermediate output as data flows through the model. As an example, model instrumentation of each layer may be used in order to analyze the internals of the model. It may instrument models to analyze the quality of training (e.g., performance, robustness, explainability, etc.). This process may include a model decomposition, wherein a model may be separated and/or grouped into smaller decomposed components. Model decomposition may be used for instrumenting parts of the model, such as, but not limited to, layers, neurons, operations, inputs, outputs and/or modules, etc. It may include layer-wise analysis, in which each deconstructed layer is analyzed, for example, for robustness, explainability, performance, and/or accuracy, etc. Decomposed components may be compared using layer-wise analysis (e.g., to other decomposed components in the model, and/or to decomposed components in other models, etc.). Data may be passed through the full model and/or through individual decomposed components to analyze and/or compare its behavior, gradients, inputs, and/or outputs, etc. The results of this example of an analysis and/or comparison may be used to improve instrumentation of the current model and/or other models. Layer-wise analysis may include the use of saliency maps for visualizing what parts of a model and/or input data are most important for the predictions made by the model.

### 2.5) Component Analysis

A Component Analysis 220 module may be used to select and/or analyze features from one or more decomposed components. Features may be provided to a Data Encoder 225 to create representations of Input AI Artifacts 205 and/or decomposed components, dependencies, etc. Features may include, but are not limited to, operator type, gradients, quantized gradients, average gradients, maximum gradients, edges, neurons, amount of neurons, input shape, output shape, gradient shape, and/or intermediate representation, etc. A Component Analysis 220 module may include one or more algorithms for selecting one or more features, including, but not limited to, principal component analysis (PCA), chi-squared test, univariate selection, correlation analysis, recursive feature elimination, forward selection, information gain, and/or Fisher's score, etc.

### 2.6) Data Encoder

A Data Encoder 225 module may encode selected features. These may be used to later reference Input AI Artifact(s) 205 and/or data about those artifacts. Encoding may include, but is not limited to, one-hot encoding, binary numbers, ordinal encoding, hash encoding, categorical variables, target encoding, and/or frequency encoding, etc. Data may be encoded to be stored in a database, such as, but not limited to a graph database and/or vector database. For example, for a vector database, one or more vectors may be used to generate vector embeddings. These embeddings may be normalized and/or modified, etc. An embedding model may be used, such as but not limited to Word2Vec, CLIP, and/or GloVe, etc. Output from a Data Encoder 225 may be provided to a Similarity Analysis 230 module, a Supply Chain Analysis 235 module, a Model Database System 240 module and/or Output Report Generation 245, etc.

### 2.7) Similarity Analysis

A Similarity Analysis 230 module may analyze the similarity between, for example, one or more Input AI Artifacts 205, Component Analysis 220 outputs, Data Encoder 225 outputs, and/or data stored in a Model Database System 240, etc. For example, layers may be compared across a target model and model(s) in a Model Database System 240 module. This module may include calculating one or more signatures, which may include, but is not limited to, a vector representation of a portion or all of the model, and/or a hash of a portion or all of the model, etc. Data that may be included in the signature may include, but is not limited to, all and/or part of the model weights, the sequence of nodes, parameters, neurons, layers, amount of operators, amount of operator types, model inputs, model outputs, intermediate inputs, intermediate outputs, binary data sections, etc. A signature may be generated, for example, by providing a model with example data and monitoring, using Model Instrumentation 215 for example, the activations and/or outputs of intermediate layers and/or the entire model. It may include a combination of multiple aspects of the model. For example, a signature may include its operator type and its weights. Multiple signatures may represent the same model. Weights may be represented in a minimized format, such as, but not limited to, calculating the average, maximum, minimum, median, etc., of a portion and/or all of the weights.

This may be used to evaluate if a provided model has a relation to an existing known model. It may be used to determine changes made between a provided model and one or more other models, such as, but not limited to, changes in operations, changes in weights, added layers, removed layers, changed layers, changed input, and/or changed output, etc. It may provide an output detailing the differences between AI artifacts. It may provide a score, such as, but not limited to, the percentage difference between AI artifacts, a score detailing whether a similar model could be found, the amount of similar AI artifact(s) found, and/or the confidence that a similar AI artifact was found, etc. This module may be used to find previously analyzed layers and models with the highest similarity. It may include sensitivity analysis that assesses how the model and its layers react to small changes to the input data. It may run over a Model Database System 240 module to modify the relationships between Input AI Artifacts 205 and their data. It may provide output to, for example, a Supply Chain Analysis 235 module, a Model Database System 240 module, and/or Output Report Generation 245, etc. Similarity Analysis 230 algorithms may include, but are not limited to, Centered Kernel Alignment (CKA), Canonical Correlation Analysis (CCA), Jaccard Index, cosine similarity, Euclidean distance, hamming distance, and/or Dice-Sørensen coefficient, etc. Using this technique, for example, it may determine the version of models by predicting the order in which models were, for example, trained. As an example, a Similarity Analysis 230 module may evaluate the difference in model weights. It may compare one or more feature from one or more signature. It may be used to analyze transfer learning by comparing representations learned by AI models, for example, by using a Large Language Model to generate example data to determine the difference in responses provided, using a Large Language Model to generate example data to determine how the underlying layers changed, running original and fine-tuned datasets through both sample models, using methods like CKA and/or CCA to determine the difference in representations, using surrogate modeling to approximate the relationship between multiple layers, using CKA on a single model's representations to determine the quality of training between layers and then comparing signatures between models, and/or generating sample data by iteratively modifying data to determine a model's performance, robustness, explainability, and/or sensitivity, etc. It may evaluate for semantically similar signatures and/or identical signatures. It may take a differential of weights between layers of a model and/or between models, etc.

### 2.8) Supply Chain Analysis

A Supply Chain Analysis 235 module may analyze to find supply chain risks of the Input AI Artifacts 205. For example, it may report that a dataset came from a vendor with a low trust score. It may report that a dataset resembles other vulnerable datasets. It may analyze results of Similarity Analysis 230 and find that the dataset contains similar, yet perturbed data in its dataset. It may find that the AI model was derived from a model that is vulnerable to one or more evasion attacks and/or had its training data poisoned. It may find that the AI model architecture contained a backdoor function. It may find that the original model's dataset is not publicly available, which may make it a risk. A Supply Chain Analysis 235 may receive input from and/or provide output to, but is not limited to, a Model Database System 240, Output Report Generation 245, and/or Similarity Analysis 230, etc. Issues regarding adversarial attacks, performance issues, and/or model sensitivity issues may persist across fine-tuned versions of a model. A Supply Chain Analysis 235 may test whether these issues persist to a target model under analysis based on prior identical and/or semantically similar signatures. It may compare how an adversarial attack performed against a previous model in its supply chain and against a target model. It may record this data in a Model Database System 240.

### 2.9) Model Database System

A Model Database System 240 module may be a data store that stores information on AI Input Artifacts 205 and/or the outputs derived from one or more modules in an Analysis System 200. It may include, but is not limited to, AI models and their decomposed components, such as but not limited to layers and/or neurons, etc. It may collect, process, and/or analyze vast amounts of data relating to AI Input Artifacts 205. For example, it may create graph the lineage of a dataset and/or AI model, etc. It may integrate data from one or more sources. It may include visualizations of data. It may manage versions of AI models, including but not limited to information on engineers involved, data sources, and/or formats, etc. It may be used to detect anomalies, such as, but not limited to, a new engineer modifying a dataset and/or model, new function(s) added to a model's architecture, and/or new modified sections of a binary, etc. It may be a single data store or it may be multiple. For example, it may include, but is not limited to, a vector database, graph database, time-series database, key-value database, network database, object-oriented database, and/or NoSQL database, etc. It may include multiple different types of databases. For example, information regarding an AI artifact's lineage may be stored in a graph database, while similarity analysis may be performed using a vector database. A Model Database System 240 may interact with one or more other components in an Analysis System 200.

### 2.10) Output Report Generation

Output Report Generation 245 may include, but is not limited to, a report, threat index, recommended actions and/or defenses, data quality alerts, model performance degradation, vulnerability detection, compliance metrics, data provenance tracking, layer-wise vulnerability metrics, and/or risk score mappings, etc. Defenses may include, but are not limited to, executing and/or guiding changes based on prior models in a target model's supply chain and/or new defenses based on prior analysis. Defenses may include, but are not limited to, fine-tuning the model with data that improved the performance, robustness, explainability, efficiency, and/or sensitivity of prior models, fine-tuning the model by merging weights and/or layers with similar models and/or prior models in a target model's supply chain, removing and/or adding modules and/or layers to a model based on successful defenses in similar and/or prior models, guiding users through changes to make to the source code of their model, guiding users through what data and/or transformations to make to their data, and/or migrating the model to a new format, etc.

### 3) Functional Diagram of a Model Database System

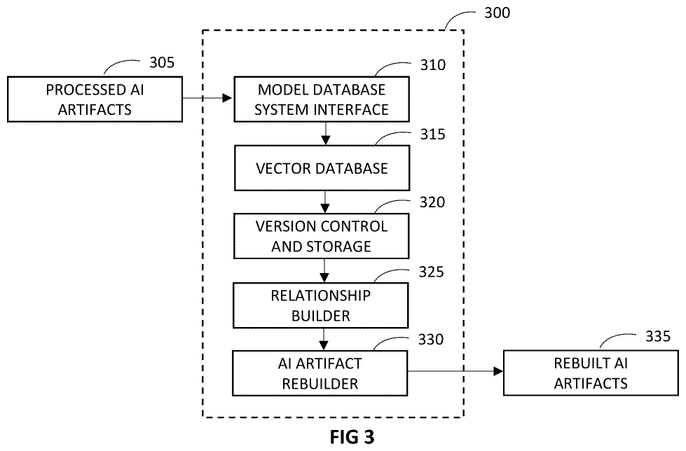

FIG. 3 depicts an example of a Model Database System 300 in the context of it being used in an Analysis System to track and store data about Processed AI Artifacts 305. In this example, Processed AI Artifacts 305 are indexed in a Vector Database 315 and in a Version Control and Storage 330 module. It may break down Processed AI Artifacts 305 into smaller components. It may share them amongst other Processed AI Artifacts 305 in order to share information and/or save storage. This process may be reordered. It may include other steps not included in this figure and/or steps may be removed in other examples.

### 3.1) Model Database System

In an example, a Model Database System 300 may be a central repository for storing, processing, and/or analyzing data from Processed AI Artifacts 305. It may store them in an efficient manner. It may determine their relationships to other artifacts. By indexing Processed AI Artifacts 305 in Vector Database(s) 315, Version Control and Storage 320 module(s), and/or other repositories, etc. a Model Database System 300 may facilitate fast query, aggregation, and sharing of insights. It may enable users to develop more performant resilient, explainable, and/or adaptive, systems. It may be hosted on a single system. It may leverage distributed computing architectures, such as, but not limited to, cloud-based services, and/or edge devices, etc. It may leverage parallel processing, distributed processing, and/or load balancing, etc.

### 3.2) Processed AI Artifacts

In an example, Processed AI Artifacts 305 may include any AI Artifacts that have been previously processed by any module in an Analysis System. For example, it may include trained AI models, lifted AI models, compiled AI models, datasets, configuration files, performance results, datasets that have been sanitized by a module in an Analysis System, and/or data retrieved and processed from other sources, etc. Processed AI Artifacts 305 may be provided to a Model Database System Interface 310.

### 3.3) Model Database System Interface

A Model Database System Interface 310 may be an interface that enables one or more users, systems, and/or modules within an Analysis System, to interface with a Model Database System 300. For example, users may use this interface to insert processed AI models into a database. It may be used to query a database. It may be used to retrieve a Rebuilt AI Artifact 335. It may be but is not limited to being accessible via a graphical user interface (GUI) that allows users to browse and/or search for specific AI artifacts stored within the Model Database System 300. It may provide APIs that enable developers to programmatically extract and/or manipulate data from a database, such as (but not limited to) retrieving metadata associated with a specific AI model or artifact. It may support secure authentication and/or authorization mechanisms to ensure only authorized users can access and/or modify data within the Model Database System 300. It may interface with one or more other modules in a Model Database System 300 module.

### 3.4) Vector Database

A Vector Database 315 may store vectors representing Processed AI Artifacts 305 and/or other data derived from them. It may utilize advanced data compression algorithms and/or mechanisms, such as, but not limited to, quantization, and/or dimensionality reduction, etc. The database may employ indexing structures, such as, but not limited to, Hierarchical Navigable Small World (HSNW), K-means clustering, Inverted File (IVF), and/or File System with Scalar Quantization (IVFSQ). It may include one or more vector databases, such as, but not limited to, Milvus, Pinecone, FAISS, and/or Vespa, etc. It may perform operations beyond storage, such as, but not limited to, re-indexing vectors, calculating similarity scores between entities, and/or modifying vectors, etc. It may be used to detect patterns between vectors representing Processed AI Artifacts 305 and/or other data derived from them. It may provide or receive data from one or more modules. It may interface with other Vector Databases 315.

### 3.5) Version Control and Storage

Version Control and Storage 320 may track and store versions of Processed AI Artifacts 305. It may leverage a Vector Database 315 to determine similar AI Artifacts. It may determine which AI Artifacts are versions of each other and/or which was derived first. It may implement a hierarchical data structure. It may comprise branches, tags, and/or revisions (e.g., representing updates to an underlying Processed AI Artifact 305. It may track an AI Artifact's lineage and/or ancestry. It may employ mechanisms to reduce storage, for example, by tracking shared data across versions. For example, if two versions of an AI model use the same architecture but not the same weights, only the changed weights may be stored. It may include a metadata repository containing information about each revision, including but not limited to timestamps, usernames, user IDs, emails, and/or descriptions of modifications, etc. It may include information about conflicts, for example, in cases where it cannot determine which version was derived first. It may provide or receive data from one or more modules. It may interface with other Version Control and Storage 320 modules.

### 3.6) Relationship Builder

A Relationship Builder 325 may find relationships between one or more Vector Databases 315 and/or Version Control and Storage 320 modules. It may be used to create a unified view of a Processed AI Artifact 305 and/or its changes over time. For example, it may identify which fine-tuned models correlate with improved robustness or explainability. It may find and/or build relationships between data not previously discovered. For example, if the first and third AI model versions are provided to the database in a model's provenance, and then the second version is provided, that new context may be used to build relationships between all three. It may enable users to visualize and/or query relationships between one or more Processed AI Artifacts 305.

### 3.7) AI Artifact Rebuilder

An AI Artifact Rebuilder 330 may reconstruct and/or provide one or more Rebuilt AI Artifacts 335. For example, Version Control and Storage 320 may store half of a dataset in a prior version, and the other half in a new version that included additional data during training of an AI model. When querying just the new version, it may contain a reference to data in a prior version. An AI Artifact Rebuilder 330 may reconstruct the full dataset by combining the new dataset items with the dataset retrieved from the reference. It may reconstruct an AI model's architecture, wherein, for example, new layers were later included. It may provide a process of how it reconstructed data. If no changes are needed, for example, it may provide the same Processed AI Artifact 305.

### 3.8) Rebuilt AI Artifacts

Rebuilt AI Artifacts 335 may result from an AI Artifact Rebuilder 330. It may be provided to one or more users, systems, and/or modules within an Analysis System. It may include one or more outputs. It may include a True/False value if, for example, the Processed AI Artifact 305 was successfully stored.

### 4) Functional Diagram of Obtaining Models and Populating Model Database

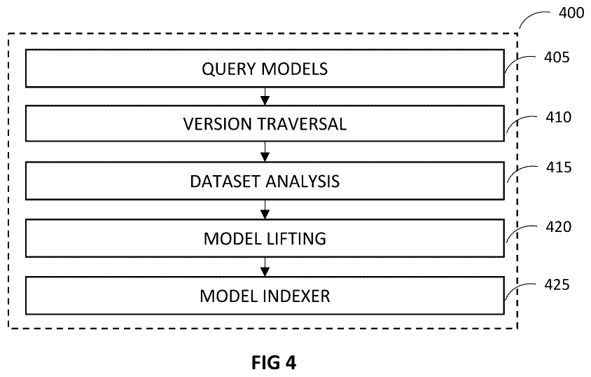

FIG. 4 depicts an example of a Model Extraction System 400 for finding, retrieving, extracting, and/or receiving models to store in a Model Database System. It may be hosted on or more systems. This process may be reordered. It may include other steps not included in this figure and/or steps may be removed in other examples.

### 4.1) Model Extraction System

A Model Extraction System 400 may be used to populate a Model Database System. It may perform analyses, such as Dataset Analysis 415, to determine if a connected dataset is applicable to a model. It may perform Model Lifting 420 to put the model into an intermediate representation for other modules in an Analysis System. It may provide the model to a Model Indexer 425 to then include in a Model Database System.

### 4.2) Query Models

A Query Models 405 module may serve as an interface for retrieving and/or extracting information for AI models and/or other AI artifacts. It may scrape data from online sources, such as, but not limited to, Hugging Face, GitHub, and/or Kaggle, etc. It may analyze locally-hosted and/or privately-hosted repositories, such as, but not limited to, directories on a file system, a locally-hosted and/or privately-hosted GitLab and/or BitBucket, etc. Models scraped may be open-source and/or closed-source. It may extract metadata and/or available information about the model, such as, but not limited to, documentation, performance metrics, training data, and/or architecture, etc. It may filter for specific criteria, such as, but not limited to, model type, model task, and/or developer, etc. It may provide data to other modules, such as but not limited to a Version Traversal 410 module.

### 4.3) Version Traversal

A Version Traversal 410 module may iterate through commits, forks, and/or branches, etc., to determine the lineage of AI models and/or other AI artifacts. It may ensure that no duplicate versions are introduced. It may provide information to a Model Indexer 425 on model lineage to, for example, simplify the process of determining the order in which models were derived. It may analyze commit history to determine the differences between versions. It may extract metadata from each iteration, such as, but not limited to, model versions, commit description, and/or date committed, etc. It may for example, but not limited to, provide dataset information to a Dataset Analysis 415 module.

### 4.4) Dataset Analysis

A Dataset Analysis 415 may extract information about the dataset(s) used. It may infer which dataset was used. For example, it may query but is not limited to, using the HuggingFace API, which dataset was used to train the model. It may determine the dataset(s) used to train, validate, and/or test the model by, but not limited to, performing natural language processing on the documentation. It may use a Large Language Model (LLM) to identify entities in the dataset name(s), type(s), and/or version(s), etc. It may provide insights into the availability of datasets and/or if the dataset was modified since the model was trained. Results of Dataset Analysis 415 may be provided to one or more modules, such as but not limited to, Model Lifting 420 and/or Model Indexer 425, etc.

### 4.5) Model Lifting

A Model Lifting 420 module in this context lifts the data derived from other modules in a Model Extraction System 400 to an intermediate representation that can be used to index data. For example, it may lift models to a common format, such as, but not limited to ONNX, TensorFlow and/or PyTorch. It may compile models to binary forms. It may normalize information about datasets. This may include normalizing timestamps, dataset formats, and/or version numbering, etc. It may provide data to, but is not limited to, a Model Indexer 425 module.

### 4.6) Model Indexer

A Model Indexer 425 module may index and/or store models in, for example, a Model Database System. It may track what models have already been extracted. It may store data, such as but not limited to the last time the extractor was run, the latest patch notes, the latest version numbers, and/or the latest commits, etc. It may output Processed AI Artifacts.

### 5) Functional Diagram of Model Version Control

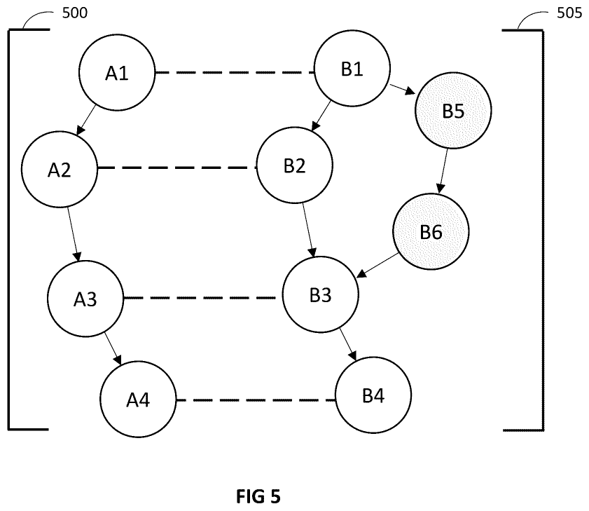

FIG. 5 depicts a simple example of model version control. In this example two models are depicted, Model A 500 and Model B 505. Model version control automatically detects that two new nodes were added. It may be hosted on one or more systems. This process may be reordered. It may include other steps not included in this figure and/or steps may be removed in other examples.

### 5.1) Model A

Model A 500 in this example contains but is not limited to 4 nodes, A1-A4. These nodes may represent, but are not limited to, operators, layers, neurons, activation functions, weights, and/or node edges, etc. If this is the first model presented to a Model Database System, they may be broken apart and/or stored in whole in one or more database. Data may be analyzed about each node in the model.

### 5.2) Model B

Model B 505 in this example contains but is not limited to 6 nodes, including a new edge from B1 to B5 and a connecting edge from B6 to B3. In this example, similarity analysis shows that A1 is similar to B1, A2 is similar to B2, A3 is similar to B3, and A4 is similar to B4. Nodes in Model A 500 may be identical to those in Model B 505. They may have similar aspects, such as the same operators but different weights. Model version control may able to determine that B5 and B6 are newly added nodes, but that the other nodes are similar and/or identical. It may be able to determine whether Model A 500 or Model B 505 were derived first. For example, it may utilize data scraped from a Model Extraction System, such as but not limited to commit date. As an example, it may determine that the weights in Model A 500 indicate older weights, since some may have been frozen during the training of Model B 505.

### 6) Functional Diagram of Model Similarity and Attack Transferability

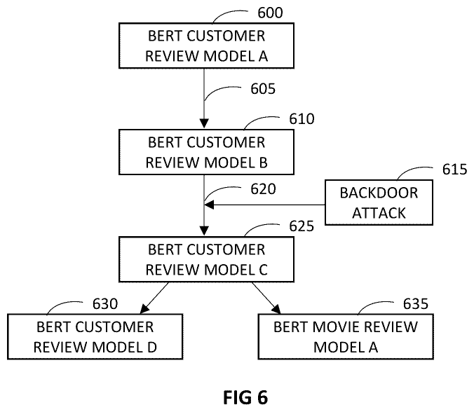

FIG. 6 depicts a simple example of model similarity and attack transferability. It depicts where in the process it may detect a potential attack on the model, and how that attack may transfer to downstream model(s). The example uses but is not limited to BERT models with customer review and movie review use cases. Model similarity and/or attack transferability may not be limited to BERT models. The use case may not be limited to customer review and movie review.

This process may be reordered. It may include other steps not included in this figure and/or steps may be removed in other examples.

### 6.1) BERT Customer Review Model A

BERT Customer Review Model A 600 in this example is a BERT classifier used on text-based customer reviews. In this example, after a model has been trained and/or fine-tuned, it is analyzed by an Analysis System. In this example, when BERT Customer Review Model A 600, no vulnerabilities and/or risks may be found.

### 6.2) Fine-tuning Customer Review Model A

Fine-tuning Customer Review Model A 605 may occur to create BERT Customer Review Model B 610. Fine-tuning may include, but is not limited to, modifying the model architecture, adding more data, modifying the learning rate, removing components of the model, and/or changing the output shape, etc. It may include but is not limited to freezing specific layers and/or modules, etc.

### 6.3) BERT Customer Review Model B

BERT Customer Review Model B 610 in this example may represent a fine-tuned version of BERT Customer Review Model A 600. It may undergo but is not limited to supply chain analysis, vulnerability analysis, explainability analysis, and/or similarity analysis, etc. In this example, it may not find any vulnerabilities and/or risks related to the model's supply chain, since the prior model contained no risks. It may have new vulnerabilities and/or risks found, for example but not limited to, during vulnerability analysis, such as, but not limited to, a backdoor placed in a function of the model and/or poisoned data introduced to the fine-tuned dataset, etc.

### 6.4) Backdoor Attack

A Backdoor Attack 615 in this example introduces a backdoor into the dataset prior to Fine-tuning Customer Review Model B 620, wherein data is introduced with a backdoor injected into one or more data points in one or more of the data classes that may enable attacks later during inference. It may include a backdoor introduced into the source code and/or compiled code of a model. It may include a backdoor in one of the software libraries.

### 6.5) Fine-tuning Customer Review Model B

Fine-tuning Customer Review Model B 620 in this example may introduce a vulnerability into the fine-tuned model. It may be introduced to try to, but is not limited to, reduce accuracy and/or confidence in the model. It may be introduced to one or more models.

### 6.6) BERT Customer Review Model C

BERT Customer Review Model C 625 may now contain the backdoor. It may be detected by an Analysis System. If it is not detected in this version but is detected in a downstream version and/or a later version of an Analysis System, results may backpropagate to this version, wherein it may be reported.

### 6.5) BERT Customer Review Model D

BERT Customer Review Model D 630 in this example may be fine-tuned and may also contain the same backdoor as BERT Customer Review Model C 625. Similarity analysis may be used to determine that BERT Customer Review Model D 630 is the next version after as BERT Customer Review Model C 625. It may detect attack transferability if it was known that BERT Customer Review Model C 625 was detected and/or reported to have a backdoor. An Analysis System may analyze BERT Customer Review Model D 630 to determine if the backdoor existed.

### 6.6) BERT Movie Review Model A

BERT Movie Review Model A 635 in this example is a new fine-tuned model of BERT Customer Review Model C 625 with a new dataset and/or task. Even in cases where the task of the model changes, an attack may still be transferrable. Similarity analysis may determine that BERT Movie Review Model A 600 is derived from BERT Customer Review Model C 625. It may detect attack transferability if it was known that BERT Customer Review Model C 625 was detected and/or reported to have a backdoor. An Analysis System may analyze BERT Movie Review Model A 635 to determine if the backdoor existed.

### 7) Functional Diagram of Analysis System for Vulnerability and Explainability Analysis

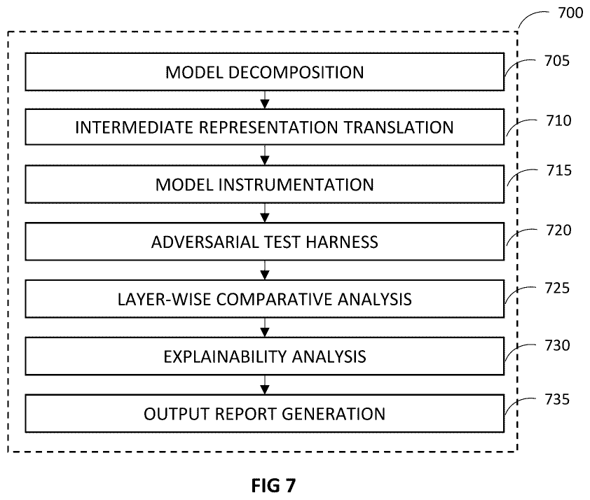

FIG. 7 depicts a simple example of vulnerability and explainability analysis in an Analysis System 700. It depicts steps in the process that may be taken to perform vulnerability and explainability analysis. The process may involve but is not limited to ingesting the model, decomposing it, performing similarity analysis, translating it to an intermediate representation, instrumenting the model, performing adversarial tests, gradient descent analysis, comparative analysis, explainability analysis, and/or output report generation. This process may be reordered. It may include other steps not included in this figure and/or steps may be removed in other examples.

### 7.1) Analysis System

In this example, an Analysis System 700 is used to perform vulnerability and explainability analysis. It may execute other analyses as well. There may be multiple vulnerability and explainability analyses. In this example, the purpose is to perform vulnerability analyses to evaluate the robustness of the model, sensitivity of the model, and/or risks relating to the model. It may explain results of those analyses, and/or of the model's decision-making and/or behavior.

### 7.2) Model Decomposition

Model Decomposition 705 may be used to distill AI models into decomposed components. For the purpose of this example, it may be used to preprocess models for one or more analyses, such as, but not limited to, an Adversarial Test Harness 720, Layer-Wise Comparative Analysis 725, and/or Explainability Analysis 730. To preprocess it, it may first analyze a baseline of how the model and its decomposed components perform when presented with different types of data that are not perturbed.

### 7.3) Intermediate Representation Translation

An Intermediate Representation Translation 710 module in this example may translate models and/or baseline data into an intermediate representation. This data may later be used to perform but is not limited to Layer-Wise Comparative Analysis 725. It may be used in one or more other modules.

### 7.4) Model Instrumentation

Model Instrumentation 715 may add hooks into decomposed components and/or decomposed components in intermediate representation(s). It may be used later to learn information about the model, such as, but not limited to, its performance, robustness, confidence, and/or behavior, etc.

### 7.5) Adversarial Test Harness

An Adversarial Test Harness 720 module may evaluate the robustness and/or performance of one or more AI models in the presence of one or more adversarial attacks. It may be automated, semi-automated, and/or manual, etc. A user may be able to control which adversarial tests are run. They may be able to manually add perturbations to data and/or specify how the attack should be carried out on the AI model. It may collect data, such as from the instrumented decomposed components, about how the model performed and/or behaved when under different types of attacks. It may create synthetic and/or perturbed data to test against the model. It may iteratively or continuously modify the attack carried out, such as increasing the amount and/or quality of the perturbations. This module enables users and/or systems to determine areas of improvement in terms of robustness and/or reliability.

### 7.6) Layer-Wise Comparative Analysis

Layer-Wise Comparative Analysis 725 may compare layers, and/or aspects of layers (e.g., neuron, inputs, outputs, gradients, and/or weights, etc.) to determine how adversarial attacks from an Adversarial Test Harness 720 impacted the model. This analysis may reveal which layers are most vulnerable to adversarial perturbations. It may determine which specific neurons or groups of neurons are disproportionately affected by one or more types of adversarial attacks. It may provide information on which layers could be further fine-tuned to improve robustness. It may identify how the adversarial attack impacts different types of layers. It may enable developers to pinpoint specific architectural weaknesses that may need to be addressed during training and/or fine-tuning.

### 7.7) Explainability Analysis

Explainability Analysis 730 may be used to explain the decision-making of AI models. It may be used to explain the results of an Adversarial Test Harness 720 and/or of a Layer-Wise Comparative Analysis 725 module. It may apply explainability techniques, such as, but not limited to, integrated gradients, counterfactual explanations, attention mechanisms, SHapley Additive Explanations (SHAP), and/or Local Interpretable Model-Agnostic Explanations (LIME), etc.

### 7.8) Output Report Generation

Output Report Generation 735 in this example may include, but is not limited to, a report detailing adversarial attacks used, specific input perturbations, perturbation patterns, attack strategy, and/or model misclassification rates. It may include but is not limited to tables or plots illustrating the changes in gradients, weights, and/or activation patterns, etc. It may indicate parts of the model that were most vulnerable to attack, such as but not limited to, which neurons, weights, and/or gradients were sensitive to adversarial inputs. It may include interpretable explanations of the reasoning behind a model's decision-making. It may include visualizations, such as but not limited to saliency maps, activation patterns, and/or feature importance scores, etc. It may include a comparison of performance metrics when under different types of attacks.

### 8) Functional Diagram of Automated Vector Generation

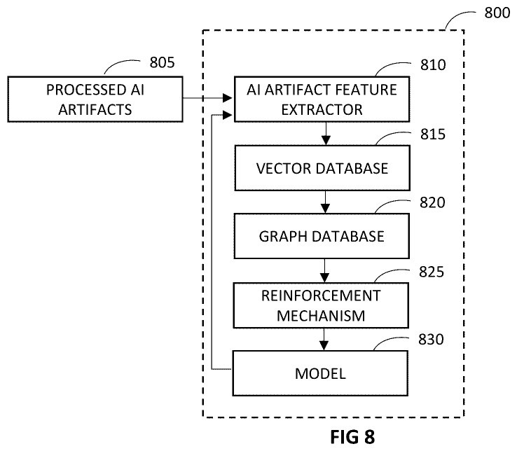

FIG. 8 depicts a simple example of a Vector Generator 800 that leverages a Model 830 to generate vectors used in a Model Database System. This process may be reordered. It may include other steps not included in this figure and/or steps may be removed in other examples.

### 8.1) Vector Generator

In this example, the objective of a Vector Generator 800 is to create vectors and iteratively improve them for example but not limited to, similarity analysis, querying accuracy, and/or querying efficiency, etc. The goal may be to generate high-quality vector representations of Processed AI Artifacts 805. It may include but is not limited to generating initial vectors, analyzing their quality using evaluation metrics, and/or then modifying them based on feedback from these assessments. Through the Reinforcement Mechanism 825, it may significantly improve its output over time and enhance downstream analysis tasks.

### 8.2) Processed AI Artifacts

In this example, Processed AI Artifacts 805 may include, but are not limited to, models, weights, and/or datasets, etc. They may already be decomposed and/or analyzed, which may be ready for including in one or more databases, such as, but not limited to, a Vector Database 815, and/or a Graph Database 820.

### 8.3) AI Artifact Feature Extractor

An AI Artifact Feature Extractor 810 may extract important features from one or more Processed AI Artifacts 805, such as, but not limited to, the amount of layers, the amount of operators, the amount of neurons, the amount of edges between operators, and/or the amount of activation functions, etc. It may leverage a Model 830 for determining which features are most important and/or how to weigh them. It may automatically identify patterns, relationships, or trends within the artifact data that may not be immediately apparent. It may assign relative importance scores to each features, enabling vectors to prioritize the most critical ones. It may remove or add features based on its analysis. It may extract various features about AI artifacts for its use in vectors.

### 8.4) Vector Database

A Vector Database 815 may be used to store vectors and enable similarity searches. In this example, it is similar to the Vector Database 315 in a Model Database System 300. It may be used to cluster similar Processed AI Artifacts 805. It may be used for querying and/or similarity searches. It may receive input and/or output data to a Graph Database 820 and/or another module.

### 8.5) Graph Database

A Graph Database 820 may store relational information in nodes and/or edges. This module may augment a Vector Database 815 by adding relationship building functionality. Its purpose is to identify patterns and correlations and optimize analysis and/or supply chain risk analysis of Processed AI Artifacts 805 and/or their decomposed components. It may receive and/or send information to a Vector Database 815. It may provide information to a Reinforcement Mechanism 825 to improve the Model 830 used to determine important features such as, but not limited to, the amount of layers, the amount of operators, the amount of neurons, the amount of edges between operators, and/or the amount of activation functions, etc.

### 8.6) Reinforcement Mechanism

A Reinforcement Mechanism 825 may be used to take in feedback from one or more other modules, users and/or from other systems to improve the Model 830. It may be informed by user feedback, such as but not limited to whether or not similar AI models were correctly clustered in a Vector Database 815 and/or whether an AI model's lineage was correct, etc. It may determine which feature is obscuring results and/or suggest to the Model 830 what features to change, remove, and/or reduce the weight of, etc. It may take into account feedback from one or more sources. Each feedback loop may enhance the accuracy and/or storage of data.

### 8.7) Model

In this example, a Model 830 may take into account important features and/or Reinforcement Mechanism 825 feedback to determine which features are most important. For example, it may find, but is not limited to, that poor results are attributed to a reliance on similarity using a specific count of operator types. It may be an algorithm and/or an AI model. It may dynamically determine which features are more significant than others. It may be used by an AI Feature Extractor 810 to weigh, remove, and/or create features for vectors.

### 9) Functional Diagram of Model Vulnerability Scanning

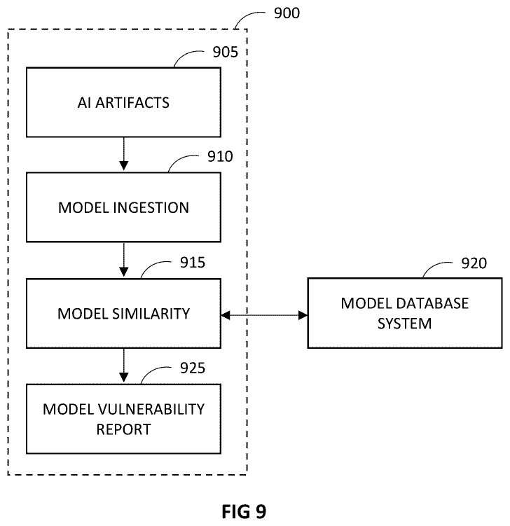

FIG. 9 depicts an example of Model Vulnerability Scanning 900, wherein a model may be scanned for vulnerabilities. This may be similar to a process of scanning executable software for malware. This process may be reordered. It may include other steps not included in this figure and/or steps may be removed in other examples.

### 9.1) Model Vulnerability Scanning

In this example, Model Vulnerability Scanning 900 may scan one or more AI Artifacts 905 for vulnerabilities. For example, it may utilize previously generated signatures of known vulnerable AI models and/or decomposed components to determine if it may contain the vulnerability. For example, if specific model weights are known to be vulnerable, and the same signature is found in a provided weights file, it may determine that there is a present vulnerable. In an example, if signatures of known vulnerable datasets are detected within a provided dataset, then it may report that there is a vulnerability.

### 9.2) AI Artifacts

In this example, AI Artifacts 905 may represent artifacts that need to be scanned for vulnerabilities. They may be obtained automatically, generated, and/or provided by one or more users and/or systems. These may be provided by, for example (but not limited to), scanning a system's files, in a CI/CD pipeline, in a DevSecOps pipeline, in an AIOps pipeline, in a MLOps pipeline, and/or in a drag-and-drop user interface, etc.

### 9.3) Model Ingestor

A Model Ingestor 910 module may ingest the one or more AI Artifacts 905 and/or prepare them for, for example but not limited to, similarity analysis. This may involve other processes, such as but not limited to, decomposition, lifting to an intermediate representation, and/or instrumentation, etc.

### 9.4) Model Similarity

A Model Similarity 915 module in this example may perform similarity analysis against a pre-existing Model Database System 920 to determine if the AI Artifacts 905 provided may be vulnerable and/or of risk, etc. It may perform similarity comparisons and/or lookups within a Model Database System 920 to determine if the AI Artifacts 905 resemble those that are known to be of risk and/or vulnerable. For example, if a user provides a BERT model that is very similar to another BERT model that is known to be vulnerable, it may be of risk. For example, if a user provides a BERT model that is a direct match and/or is a successor of a vulnerable BERT model, then it may be vulnerable.

### 9.5) Model Database System

A Model Database System 920 may be similar but not limited to the version described in FIG. 3. It may contain information on known vulnerable and/or risky artifacts and/or their parts, etc. It may have but is not limited to relevant metadata about those similar vulnerable models so that the one or more users and/or systems that receive a Model Vulnerability Report 925 may debug and/or understand where the risks come from.

### 9.6) Model Vulnerability Report

A Model Vulnerability Report 925 may have information on similar models, if they were found, that may be vulnerable and/or risky. They may be vulnerable to, for example but not limited to, backdoors, poison attacks, evasion attacks, extraction attacks, inference attacks, transfer attacks, model inversion, model stealing, and/or privacy attacks, etc. It may provide a score, a report, and/or a description of how and/or why the AI Artifacts 905 are vulnerable and/or risky, etc.

### 10) Functional Diagram of AI Compiler Instrumentation

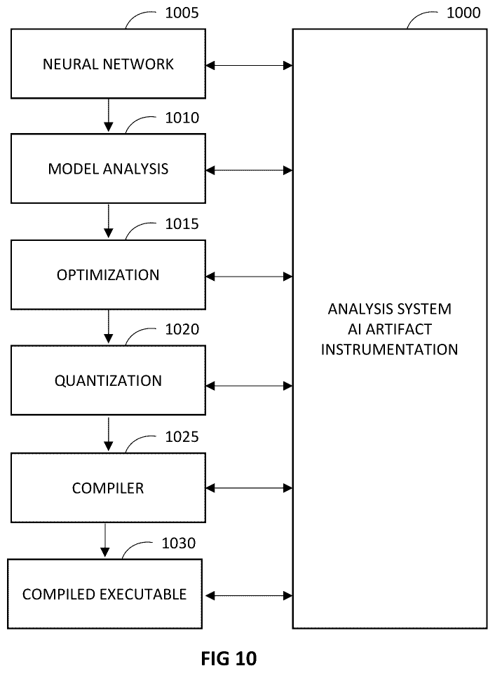

FIG. 10 depicts an example of an Analysis System AI Artifact Instrumentation 1000 component, wherein an AI compiler may be instrumented. This may be used to track and/or analyze how the Neural Network 1005 was compiled so that the compiler and/or compiled model may be used for analysis in an Analysis System. This process may be used to catalog compiled models in a Model Database System. The figure depicts some of the stages that may be present in the neural network compilation process. This process may be reordered. It may include other steps not included in this figure and/or steps may be removed in other examples.

### 10.1) Analysis System AI Artifact Instrumentation

An Analysis System AI Artifact Instrumentation 1000 module may instrument the compilation process of one or more Neural Network 1005. It may wrap functions and/or add intermediate steps to obtain logs, inputs, and/or outputs, etc., from the process. It may plug into one or more stages of the compilation process.

### 10.2) Neural Network

A Neural Network 1005 may be an AI program and/or model that makes decisions on data. It may be provided to an AI compiler like, for example but not limited to, Glow and/or TVM to enable it to run on low-compute devices, optimize its performance, and/or adapt it for a CPU architecture, etc. It may be designed to be deployed within constrained resources such as, but not limited to, limited memory, limited storage, and/or compute power. It may make it suitable for deployment in, for example but not limited to, embedded systems, edge devices, IoT devices, Operational Technology (OT) devices, and/or other applications where traditional cloud-based AI models are not feasible.

### 10.3) Model Analysis

A Model Analysis 1010 module may be used by an AI compiler to assess, for example (but not limited to) performance metrics, robustness metrics, activation functions, weights, weight types, computational complexity, etc. Instrumentation may be used to evaluate its analysis processes to understand its decision-making. It may identify potential bottlenecks, optimize performance components, and/or suggest areas for improvement, etc.

### 10.4) Optimization

An Optimization 1015 module within an AI compiler may leverage techniques to minimize computational complexity and/or memory and/or storage needs. It may maintain and/or maximize a Neural Network's 1005 accuracy and/or robustness. Instrumentation of this process may provide specific information on which specific optimizations were made and/or what changes were made to the model, etc.

### 10.5) Quantization

A Quantization 1020 module in an AI compiler may reduce the precision of model parameters to smaller data types. Instrumenting this process would be important to understand what smaller data types were used and/or what data may have been lost in this process, etc.

### 10.6) Compiler

A Compiler 1025 module in an AI compiler may translate and/or compile an optimized model into an executable format. This format may be directly used by a device's processor. It may be compiled for but is not limited to a specific CPU architecture. It may enable use of specialized processors and/or GPUs. It may minimize storage. It may be compiled with static or dynamic libraries. This process can be instrumented to create a record of how the model was compiled, what compiler was used, and/or what libraries were used, etc.

### 10.7) Compiled Executable

A Compiled Executable 1030 may be a compiled model ready to be executed on a system. It may be instrumented in that during the inference process, intermediate inputs and outputs may be made available to an Analysis System. It may collect data from instrumentation, such as but not limited to, performance metrics, gradients, inputs, and/or outputs, etc.

### 11) Functional Diagram of Analysis System Reverse Engineering AI Models for Analysis

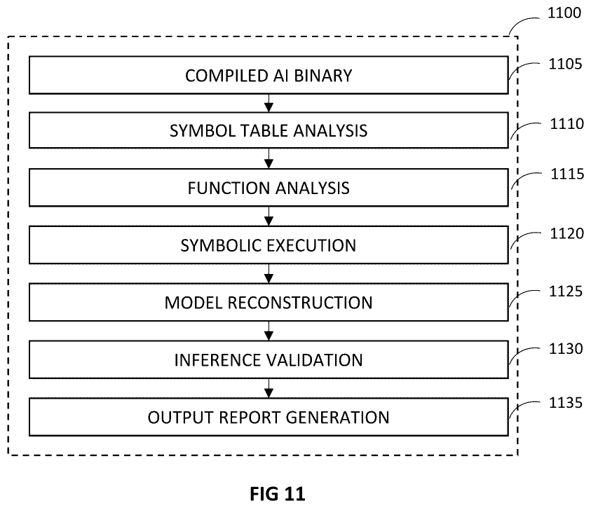

FIG. 11 depicts an example of an Analysis System 1100, wherein it may analyze one or more Compiled AI Binaries 1105 and prepare them for analysis for other modules, such as, but not limited to similarity analysis and/or vulnerability analysis. This process may be reordered. It may include other steps not included in this figure and/or steps may be removed in other examples.

### 11.1) Analysis System

An Analysis System 1100 may take in a Compiled AI Binary 1105 as an AI Artifact input and/or output a report, which may be used for other analyses. It may enable the analysis of compiled models. These AI models may be compared to AI models that have not been compiled in other analyses. It may compare AI models to AI models compiled for other architectures or with different AI compilers in downstream analyses.

### 11.2) Compiled AI Binary

A Compiled AI Binary 1105 may come in various forms, such as but not limited to Glow, TVM, MLIR, XLA, Halide, and/or TensorRT, etc. It may be compiled for architectures such as, but not limited to, ARM, x86, MIPS, PowerPC, and/or RISC-V, etc. It may be compiled for specialized hardware, such as, but not limited to, FPGA, ASIC, and/or GPU.

### 11.3) Symbol Table Analysis

A Symbol Table Analysis 1110 module may analyze a binary's symbol table to determine relevant symbols to AI. It may identify symbols with names that relate to, for example but not limited to, weight matrices, bias vectors, and/or activation functions, etc. The engine may interact with a similarity analysis module and/or Model Database System search to find known symbols. It may have a mapping of known symbols and/or it may use an algorithm and/or AI to infer relevant symbols. It may detect anomaly and/or outlier symbols, such as symbols that should not be present in a computer vision model that are relevant to a language model. These identified symbols may be provided to other modules in this example to target specific variables and/or functions to analyze.

### 11.4) Function Analysis

A Function Analysis 1115 module may determine functions relevant to AI. It may identify specific functions that correlate to the original AI model, such as but not limited to, forward pass, backward pass, softmax activation, and/or convolutional neuron, etc. It may determine how functions are likely to be ordered and/or analyze its Control Flow Graph (CFG), etc. It may use similarity analysis and/or lookups and/or searches in a Model Database System to determine information about one or more functions. It may determine information such as, but not limited to, the architecture, model type, model task, framework, compiler, quantization and/or optimization, etc., based on its functions.

### 11.5) Symbolic Execution

A Symbolic Execution 1120 module may use a symbolic execution engine, such as but not limited to angr, KLEE, and/or a custom engine, etc. It may simulate use of the model, determining information such as, but not limited to, which functions were visited, the order of functions visited, the inputs and/or outputs of a function, the weights, etc. It may utilize similarity analysis and/or lookups and/or searches in a Model Database System to find similar prior outputs from other AI models.

### 11.6) Model Reconstruction

A Model Reconstruction 1125 module may rebuild a Compiled AI Binary 1105 into a format that may be analyzed and/or stored by an Analysis System 1100. It may put the model into an intermediate representation. It may deduce information from one or more module, such as but not limited to Symbol Table Analysis 1110, Function Analysis 1115, and/or Symbolic Execution 1120, etc. The output of this module may be a reconstructed model and/or steps to reconstruct the model, etc.

### 11.7) Inference Validation

An Inference Validation 1130 module may validate that inference is similar and/or identical between the compiled AI model and the reconstructed model. It may analyze the behavior of individual layers. It may cross-reference similar decomposed components of the reconstructed model to similar decomposed components in a Model Database System.

### 11.8) Output Report Generation

Output Report Generation 1135 may include, but is not limited to, a reconstructed model, vulnerabilities found in the model, weights, activation functions, functions used, compiler used, optimizations used, quantization used, framework used, risks, and/or performance metrics, etc.

### 12) Functional Diagram of Dataset Signature Generation

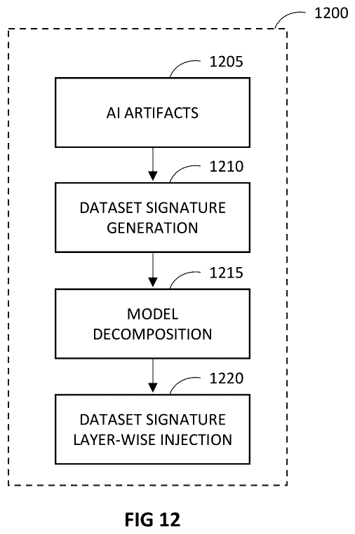

FIG. 12 depicts an example of an Analysis System 1200, wherein it may generate a signature that represents the original dataset. This may prove that the original dataset was unchanged. It may prove that the original dataset does not contain backdoors and/or poisoned data. The purpose of this module may be to ensure that the dataset has not been tampered with and/or to prove that the dataset that is claimed to be used to train a model is correct. This process may be reordered. It may include other steps not included in this figure and/or steps may be removed in other examples.

### 12.1) Analysis System

An Analysis System 1200 may be used to generate signatures of one or more AI Artifacts 1205. This example demonstrates signature generation for datasets. However, it may not be limited to just datasets. It may generate signatures of other AI Artifacts 1205 such as but not limited to AI models, weights, architectures, layers, and/or tasks, etc.

### 12.2) AI Artifacts

In this example, AI Artifacts 1205 may be datasets and/or AI models, wherein there is a need to generate a dataset signature.

### 12.3) Dataset Signature Generation

A Dataset Signature Generation 1210 module may generate a signature. It may create a unique fingerprint, checksum, and/or hash. It may be used to ensure the integrity of the dataset. It may be used to ensure the dataset has not been tampered with. It may use, but is not limited to, an AI technique to generate the signature. It may make modifications to the original dataset, such as but not limited to, inserting a watermark. A user and/or system may later validate that the dataset remains unchanged.

### 12.4) Model Decomposition

A Model Decomposition 1215 module may break down a model into smaller decomposed components. In this example, the purpose may be to later insert a signature before and/or after training into the model.

### 12.5) Dataset Signature Layer-Wise Injection

A Dataset Signature Layer-Wise Injection 1220 module may be used to inject results of a Dataset Signature Generation 1210 module into the decomposed components from a Model Decomposition 1215 module. The objective is to combine the model and the dataset signature to enable integrity checks in a manner that they cannot be separated. This module may enable a robust validation mechanism against but not limited to adversarial attacks or malicious data insertion. It may ensure that only authentic datasets are used to train models. It may mitigate risks of vulnerabilities being introduced during training, and/or may add trust in the model and/or its dataset.

### 13) Functional Diagram of Analysis System in AIOps Process

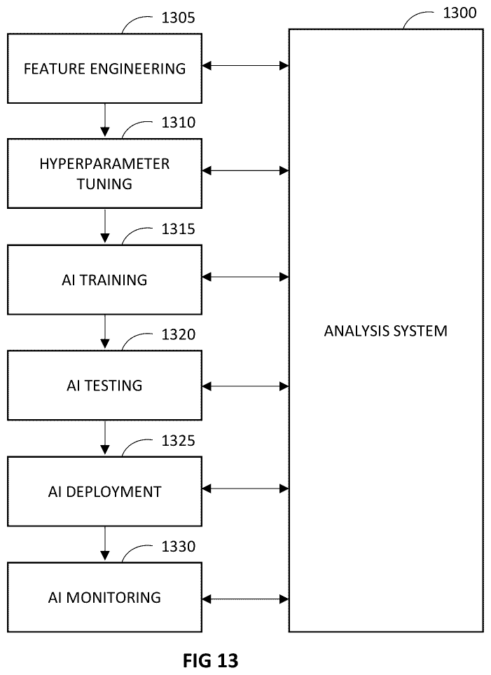

FIG. 13 depicts an example of an Analysis System 1300, wherein it may be used in one or more steps of an AIOps process. It depicts, but is not limited to, an example AIOps process and the steps in which an Analysis System 1300 may provide benefits and/or be integrated. AIOps pipelines may include, but are not limited to, Splunk, BigPanda, Datadog, Zluri, and/or AppDynamics, etc. This process may be reordered. It may include other steps not included in this figure and/or steps may be removed in other examples.

### 13.1) Analysis System

In this example, an Analysis System 1300 may be used to analyze and/or catalog, etc., a model during an AIOps pipeline. This may include processing datasets, models, source code, and/or other AI Artifacts during the AIOps process. It may be used to improve the AIOps process, such as determining if a dataset has poisoned data and/or was derived from a model that had poisoned data. It may notify steps in the AIOps pipeline that data should be modified in a specific way to make it more accurate and/or robust. It may catalog the model after it has been trained and/or analyze it.

### 13.2) Feature Engineering

During a Feature Engineering 1305 step, the AIOps pipeline, wherein data features may be processed and/or transformed to prepare them for training an AI model. The primary goals are to enhance the accuracy, robustness, interpretability, and/or trustworthiness, etc., of the model by selecting and/or transforming important features, such as but not limited to reduce dimensionality, reduce duplicate data, and/or to filter and/or identify relevant features. An Analysis System 1300 may be used in this step, for example (but not limited to), to analyze the data for backdoors, to find similar data to find what models exist, to find similar data to determine the prior performance of models that exist that used it, to analyze the data for poisoned attacks, to find sensitivity issues in the data, to detect data that may potentially be out-of-distribution but is still relevant to the data, to augment the data, and/or to generate synthetic data, etc.

### 13.3) Hyperparameter Tuning

During a Hyperparameter Tuning 1310 step, the AIOps pipeline may search and/or identify the best parameters to achieve optimal performance and/or robustness. It may involve utilizing algorithms such as, but not limited to, grid search, random search, manual search, and/or Bayesian optimization. An Analysis System 1300 may be used in this step to, for example (but not limited to), to find prior similar models and hyperparameters that were effective, automatically select the best hyperparameters, and/or to integrate configurations into the Model Database System, etc.

### 13.4) AI Training

In this example, AI Training 1315 in an AIOps pipeline may be where the actual training occurs. It may leverage preprocessed features from the Feature Engineering 1305 phase and Hyperparameter Tuning 1310 step. It may utilize one or more frameworks, such as but not limited to, TensorFlow, PyTorch, and/or Keras, etc. An Analysis System 1300 may be used in this step to, for example (but not limited to), analyze the quality of training, analyze performance and/or robustness during training, and/or insert a dataset signature, etc.

### 13.5) AI Testing

In this example, AI Testing 1320 in an AIOps pipeline may validate the accuracy, robustness, and/or reliability of the model trained during AI Training 1315. It may involve but is not limited to applying automated test scripts, unit tests, and/or end-to-end test to validate preprocessing, inference, and/or postprocessing steps. An Analysis System 1300 may be used in this step to, for example (but not limited to), analyze the quality of testing, analyze performance and/or robustness after training, catalog the model, validate the dataset signature, and/or find prior models with similar performance metrics, etc.

### 13.6) AI Deployment

In this example, AI Deployment 1325 in an AIOps pipeline may be the step where models are integrated into their production environment(s). It may enable them to provide inference results. It may compile the model to an executable prior to deployment. It may package other dependencies, source code, frameworks, and/or libraries, etc. It may utilize containerization, such as but not limited to Docker and/or K8s Pod and/or orchestrated through systems, such as but not limited to Docker Swarm Mode and/or Kubernetes, etc. An Analysis System 1300 may be used in this step to, for example (but not limited to), analyze and/or instrument the compilation process, analyze and/or instrument the compiled binary, validate the compilation process, and/or perform runtime behavior analysis, etc.

### 13.7) AI Monitoring

In this example, AI Monitoring 1330 in an AIOps pipeline may enable real-time analysis of, for example (but not limited to) model performance, anomalies, memory usage, storage usage, system health, bottlenecks, and/or user experience. It may enable one or more users and/or systems to identify and defending against issues, anomalies, vulnerabilities, and/or optimize model behavior, etc. It may integrate with other monitoring tools. An Analysis System 1300 may be used in this step to, for example (but not limited to), monitor and perform comparative analysis of inputs and outputs, detect inputs and/or behavior resembling adversarial attacks, and/or monitor degradation to models over time, etc.

### 14) Functional Diagram of Analysis System for Use Case Identification

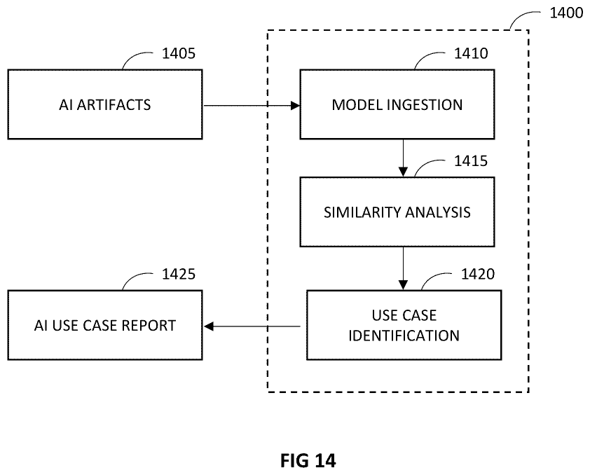

FIG. 14 depicts an example of an Analysis System 1400, wherein it may be used to detect one or more relevant use cases and/or dataset. The objective is to determine, based on existing AI Artifacts 1405, what other use cases and/or datasets may be effective. This process may be reordered. It may include other steps not included in this figure and/or steps may be removed in other examples. In an example, an Analysis System 1400 may provide suggestions for the model based on prior similar use cases and/or, etc.

### 14.1) Analysis System

In this example, an Analysis System 1400 may be used to detect other use cases and/or datasets that the AI Artifacts 1405 may be effective for. For example, it may look at similar data types in a Model Database System to find similar data, and/or similar models that were effective, etc.

### 14.2) AI Artifacts

In this example, AI Artifacts 1405 may be used as input to determine other relevant use cases and/or datasets. It may be, for example but not limited to, a trained model with weights and/or other dependencies included.

### 14.3) Model Ingestion

A Model Ingestion 1410 module may support a variety of frameworks and/or model formats. It may ensure compatibility with an Analysis System 1400 and/or may leverage decomposition, instrumentation, and/or lifting to an intermediate representation, etc. It may receive one or more AI Artifacts 1405.

### 14.4) Similarity Analysis

A Similarity Analysis 1415 in this example may find but is not limited to, datasets, models, architectures, and/or use cases, etc., that may be relevant for the provided AI Artifacts 1405. It may predict, for example but not limited to, which datasets would perform well with a provided AI model. It may do this using algorithms and/or AI models, etc. It may utilize a Model Database System to perform lookups and/or similarity searches in one or more databases.

### 14.5) Use Case Identification

A Use Case Identification 1420 module may be used to identify relevant use cases based on the results of Similarity Analysis 1415. It may identify other scenarios, applications, and/or industry verticals that would effectively utilize the model and/or dataset, etc.

### 14.6) AI Use Case Report

An AI Use Case Report 1425 may include, but is not limited to, other datasets, models, and/or use cases that may be applicable to a model. It may find other datasets that could augment a trained model during fine-tuning. This process may, for example (but not limited to) accelerate the development cycle for future AI models, suggest alternative combinations that may improve accuracy and/or robustness, etc., and/or streamline the data curation process, etc.

### 15) Functional Diagram of Analysis System for Identifying Optimal Models Based on Input

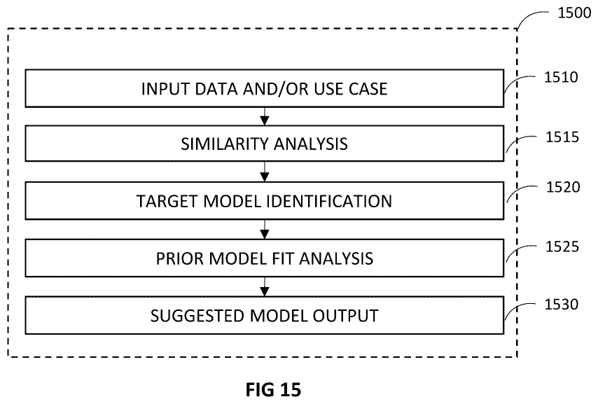

FIG. 15 depicts an example of an Analysis System 1500, wherein it may be used to detect one or more relevant models based on one or more Input Data and/or Use Case 1510. The objective is to determine the most optimal models by searching and/or analyzing a Model Database System. This process may be reordered. It may include other steps not included in this figure and/or steps may be removed in other examples.

### 15.1) Analysis System

In this example, an Analysis System 1500 may be used to find and/or analyze models and/or model architectures that would best meet the needs of one or more provided Input Data and/or Use Case 1505.

15.2) Input Data and/or Use Case

One or more Input Data and/or Use Cases 1505 may be provided to an Analysis System 1500 to determine one or more Suggested Model Outputs 1530. Input data may include, but is not limited to, text, images, videos, audio, numerical, categorical, network traffic, time-series, and/or sensor data and/or a combination. Use cases may include, but are not limited to, factory parts predictive maintenance, reviews sentiment analysis, stock financial analysis, assembly line quality control, cancer diagnosis, and/or autonomous vehicle object recognition, etc.

### 15.3) Similarity Analysis

In this example, a Similarity Analysis 1510 module may find similar datasets, data types, and/or use cases to the provided Input Data and/or Use Cases 1505. It may perform searches in one or more Model Database Systems. It may utilize a variety of similarity features to perform searches. It may use AI, such as a LLM, to generate queries to one or more databases. It may include a ranking according to confidence and/or similarity scores, etc.

### 15.4) Target Model Identification

A Target Model Identification 1515 module may filter the results of similarity analysis. It may filter based on, for example (but not limited to), model explainability, model dependencies, user-provided filters, user-provided requirements, versioning, frameworks used, etc. It may prioritize models based on a ranking and/or confidence and/or similarity score provided by a Similarity Analysis 1510 module.

### 15.5) Prior Model Fit Analysis

A Prior Model Fit Analysis 1520 module may analyze models provided by a Target Model Identification 1515 module in more depth. It may assess the models' performance on representative data samples. It may estimate their benefits and drawbacks for the provided Input Data and/or Use Cases 1505. It may partially train one or more models and predict their resulting performance and/or other metrics. It may determine their suitability for the target application. It may balance metrics such as, but not limited to, accuracy, robustness, reliability, and/or explainability, etc.

### 15.6) Suggested Model Output

Suggested Model Output 1530 may be presented, for example (but not limited to) in a user-friendly format, such as but not limited to, a link to one or more suggested models, a list of suggested models, with the original model's performance metrics, with a trained model using the suggested model, and/or with a pipeline to train using the suggested model, etc.

### 16) Functional Diagram of Analysis System for Migrating to Another Model

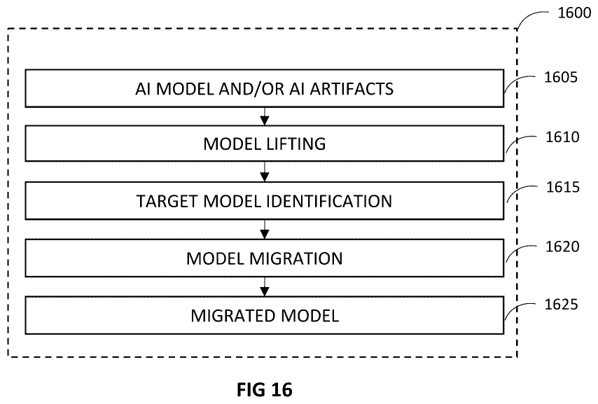

FIG. 16 depicts an example of an Analysis System 1600, wherein it may be used to migrate for example but not limited to an AI model and/or AI Artifacts 1605 to another format. It may be used, for example but not limited to, migrate a model fine-tuned based on another model to an upgraded and/or modified version of the original model it was derived from. This process may be reordered. It may include other steps not included in this figure and/or steps may be removed in other examples.

### 16.1) Analysis System

In this example, an Analysis System 1600 may be used to migrate an AI model and/or AI Artifacts 1605 to another format. For example, a BERT model may be modified to have additional layers. If another model was fine-tuned based on the original version, it would not have those additional layers. This example of an Analysis System 1600 may be used to convert AI model and/or AI Artifacts 1605 into the new version. It may include migrating to another AI model architecture and/or CPU.

16.2) AI model and/or AI Artifacts

In this example, AI model and/or AI Artifacts 1605 may include, but are not limited to, a trained model, a model architecture, weights, sample data, a compiled model, and/or source code, etc. One or more AI model and/or AI Artifacts 1605 may be expected to be migrated during this process.

### 16.3) Model Lifting

In this example, a Model Lifting 1610 module may lift the AI model and/or AI Artifacts 1605 into a format that is ideal for migrating. This may be an intermediate format such as but not limited to ONNX, where it is feasible to add, modify, and/or remove layers, etc. It may include other metadata and/or instructions on how to utilize and/or deploy the model.

### 16.4) Target Model Identification

A Target Model Identification 1615 module may determine the AI model to migrate to. The AI model to migrate to might be provided by a user and/or system and/or it may be determined using a process similar to that in the example described in FIG. 15. It may determine one AI model to migrate to or multiple. It may determine that it is not feasible to migrate AI model and/or AI Artifacts 1605. For example, the AI model to migrate to may not be compatible with the original AI model and/or AI Artifacts 1605. The one or more AI models to migrate to may be provided to a Model Migration 1620 module which will execute the migration process.

### 16.5) Model Migration

A Model Migration 1620 module may migrate one or more AI model and/or AI Artifacts 1610 to one or more formats. It may migrate an AI model and/or AI Artifacts 1605 to a different framework. It may add, modify, and/or remove components of the AI model and/or AI Artifacts 1605. It may combine weights from one or more AI model and/or AI Artifacts 1605. It may convert data formats from one or more datasets. It may modify the original training dataset. It may train a new model using data and/or weights of the original AI model and/or AI Artifacts 1605. It may freeze layers during training and/or only train new layers.

### 16.6) Migrated Model

One or more Migrated Models 1625 may be the result of this example of an Analysis System 1600. It may include, but is not limited to, performance metrics, robustness metrics, explainability metrics, sample data, datasets, custom transform functions, AI models, compiled AI models, installation instructions and/or deployment instructions, etc.

### 17) Functional Diagram of Analysis System for Reinforcement Learning

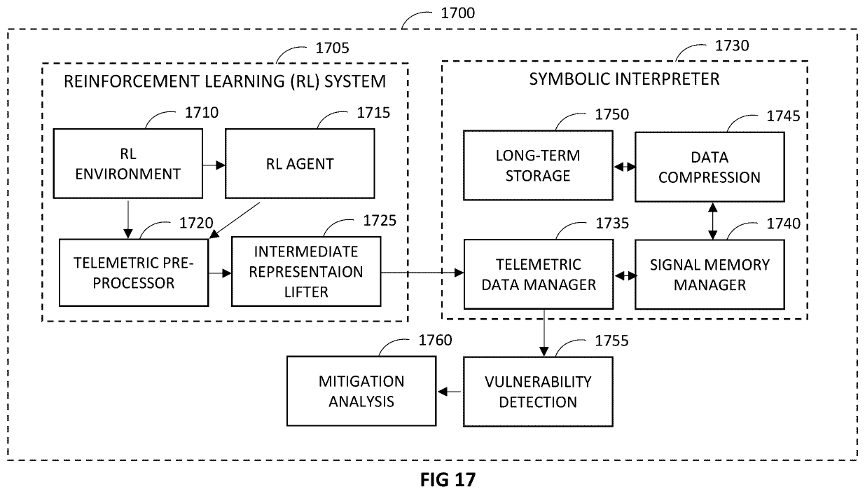

FIG. 17 depicts an example of an Analysis System 1700 used to improve reinforcement learning models. This process may be reordered. It may include other steps not included in this figure and/or steps may be removed in other examples.

### 17.1) Analysis System

In this example, an Analysis System 1700 may be used to analyze one or more Reinforcement Learning (RL) Systems 1705. It may analyze it for, but is not limited to, explainability, performance, accuracy, reliability, and/or robustness, etc. It may extract information from the decision-making process for analysis. It may integrate analysis process into the decision-making process of the system it is analyzing.

### 17.2) Reinforcement Learning (RL) System

A Reinforcement Learning (RL) System 1705 may be used to make a RL Environment 1710 and/or RL Agent 1715 more explainable. Reinforcement Learning (RL) Systems 1705 may include, but are not limited to, deep reinforcement learning, model-based reinforcement learning, actor-critic techniques, and/or value-based reinforcement learning, etc. It may include an Intermediate Representation Lifter 1725 that may create a digital twin of a system. It may be embedded in production systems. It may be able to run alongside and/or independently where it is not embedded. A digital twin may be comprised of surrogate of an RL Agent 1715. It may be equipped with enhanced observability and may obtain contextual data from an Reinforcement Learning (RL) System 1705 consisting of the RL Environment's 1710 state and the RL Agent's 1715 decision that are used to simulate the RL process, resulting in the observability data as a stream passed to a Telemetric Data Manager 1735. It may be any type of Reinforcement Learning (RL) System 1705, including but not limited to online systems, offline systems, and/or multi-agent systems, etc. The system may be optimized for a deep Reinforcement Learning (RL) System 1705 where agents include deep neural network components.

### 17.3) RL Environment

A RL Environment 1710 may be a simulated and/or virtual space where a RL Agent 1715 may learn to interact with its surroundings. It may use but is not limited to, trial and error, and/or reinforcements, etc. It may have but is not limited to states, rewards, actions, and/or penalties, etc. The RL Environment 1710 may be used to capture a snapshot of where a decision was made and provided to a Telemetric Pre-Processor 1720.

### 17.4) RL Agent

A RL Agent 1715 may learn and/or make decisions in its RL Environment 1710. It may aim to maximize one or more rewards. It may use but is not limited to one or more algorithms, statistical models, and/or AI models, etc. It may pass data, such as but not limited to its decision, to a Telemetric Pre-Processor 1720. It may be characterized from an upload.

### 17.5) Telemetric Pre-Processor

A Telemetric Pre-Processor 1720 may handle raw data acquired from a Reinforcement Learning (RL) System 1705. It may, for example but not limited to, filter out noise, normalize value, preprocess, and/or transform data to be used by an Intermediate Representation Lifter 1725.

### 17.6) Intermediate Representation Lifter

An Intermediate Representation Lifter 1725 may utilize the composition of the one or more RL Agent 1715 of a Reinforcement Learning (RL) System 1705 to model and instrument a surrogate. A key feature may be a parallel output from its layer-wise observability enhancement using the instrumentation and intermediate representation. The enhanced output may be but is not limited to a function of the layers that were instrumented, including the number of layers. This output may be passed to and/or subsequently managed by a Telemetric Data Manager 1735.

### 17.7) Symbolic Interpreter

A Symbolic Interpreter 1730 may ensure that resources are managed, primarily based on but not limited to the identification and/or elimination of noise, and/or the selective storage of signals to be used for reporting and/or feedback (i.e., symbolic reinforcement, and/or case-based reasoning, etc.), etc. This technique may serve several related benefits including but not limited to tracking/auditing and observability of the solution itself.

### 17.8) Telemetric Data Manger

In this example, a Telemetric Data Manger 1735 may process data as a stream that simulates an RL process. It may process and/or manage outputs by other modules.

### 17.9) Signal Memory Manager

A Signal Memory Manager 1740 may be but is not limited to the first layer of analysis for digital signal processing, It may utilize processing techniques such as, but not limited to, Fourier Transform and/or Wavelet Transform to identify and/or separate relevant features (i.e., signals) from noise in the telemetry data.

### 17.10) Data Compression

A Data Compression 1745 module may process the resulting subset, which may represent symbols. It may ensure that data is reliable, safe, and/or available for long-term storage, etc.

### 17.11) Long-Term Storage

In this example, Long-Term Storage 1750 may ensure availability in historical analysis, such as feedback to CBR, and/or self-improvements to the symbolic AI components. It may include, but is not limited to, cloud storage, solid-state drives, hard disk drives, and/or flash storage, etc.

### 17.12) Vulnerability Detection

In this example, Vulnerability Detection 1755 may find vulnerabilities in an RL model and/or its digital twin. This may include, but is not limited to, observation space poisoning, reward function tampering, and/or policy gradient manipulation, etc.

### 17.13) Mitigation Analysis

Mitigation Analysis 1760 may determine strategies to defend against vulnerabilities, such as, but not limited to, adversarial training, observation space filtering, and/or policy regularization, etc.

### 18) Functional Diagram of Analysis System for Explainable Reinforcement Learning

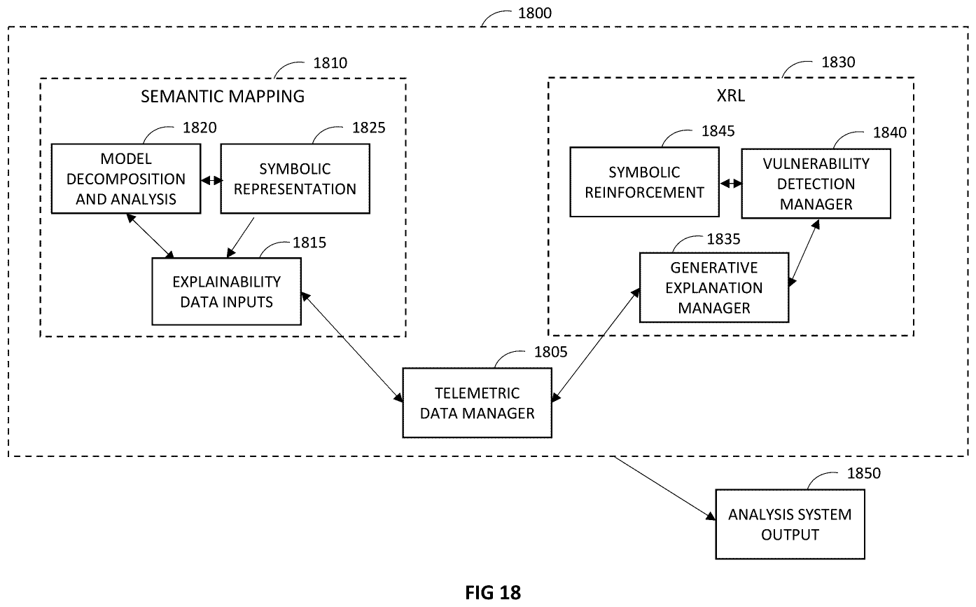

FIG. 18 depicts an example of an Analysis System 1800 used to improve reinforcement learning models with explainable reinforcement learning (XRL), building on the process described in FIG. 17. This process may be reordered. It may include other steps not included in this figure and/or steps may be removed in other examples.

### 18.1) Analysis System

In this example, an Analysis System 1800 may be used to analyze one or more RL systems for explainable reinforcement learning. It may continuously, sequentially, and/or periodically generate and/or improve explanations of decision-making and/or behavior over time.

### 18.2) Telemetric Data Manager

A Telemetric Data Manager 1805 module may be similar to the one described in section 17.7. It may send signals and/or raw data to other modules.

### 18.3) Semantic Mapping

A Semantic Mapping 1810 module may acquire signals and/or raw data. It may be but is not limited to a data analysis pipeline. It may retrieve data from a Telemetric Data Manger 1805. Multiple layers of analysis may be performed.

### 18.4) Explainability Data Inputs

Explainability Data Inputs 1815 may include techniques, such as but not limited to, LIME and/or SHAP, etc. It may use one or more techniques to extract explainability data from a Telemetric Data Manager 1805 to gain a better understanding of its decision-making. They may be extracted from data provided from one or more other modules, such as but not limited to Symbolic Representation 1825, Telemetric Data Manager 1805, and/or Model Decomposition and Analysis 1820, etc.

### 18.5) Model Decomposition and Analysis

A Model Decomposition and Analysis 1820 module may include techniques, such as but not limited to, Saliency Maps, Counterfactual Explanations, LRP, and/or Case-Based Reasoning, and/or Symbolic Analysis with techniques such as DERRL, DILP, ILP, and/or PLP, etc. It may break down Explainability Data Inputs 1815 into smaller decomposed components that that can be analyzed and/or using one or more techniques to explain its behavior and/or decision-making.

### 18.6) Symbolic Representation

A Symbolic Representation 1825 module may convert RL decision-making processes into symbolic representation. It may offer a more human-readable and understandable format. It may be used to demystify the complex operations within the neural networks of RL agents. It may make their actions and/or decisions available for but not limited to articulation, reporting, and/or automations, etc.

### 18.7) Explainable Reinforcement Learning (XRL)

An Explainable Reinforcement Learning 1830 module may receive the results of analyses passed via a Telemetric Data Manager 1805. The objective of this module is to make the actions of RL agent's more explainable.

### 18.8) Generative Explainable Manager

A Generative Explanation Manager 1835 may enhance explanation outcomes. It may advance the deployment of RL systems by enabling robust, reliable, and transparent decision-making processes. The observability and/or analysis capabilities may improve confidence in AI decisions to enhance operational effectiveness and/or mission objectives for existing (i.e., legacy) and future deployments of RL systems.

### 18.9) Vulnerability Detection Manager

A Vulnerability Detection Manager 1840 may enable vulnerability monitoring and/or analysis capabilities. It may identify weaknesses and/or vulnerabilities in real-time. This ensures operational integrity and contributes to the system's robustness and/or reliability. For example, specific types of vulnerabilities can be represented symbolically as logical operators for their detection and/or identification during the translation of the digital twin's signals to symbolic representation. These may allow real-time monitoring and in-depth analysis of the AI system's functionality. It may follow frameworks such as but not limited to MITRE ATLAS. It may utilize model decomposition and/or layer-wise analysis for creating a digital twin of complex RL systems for dynamic assessments, data generation, and/or observability outcomes that will directly translate to benefits in XRL.

### 18.10) Symbolic Reinforcement

A Symbolic Reinforcement 1845 module may enable systemic reinforcement of the symbolic AI. It may be used to improve the agent's decision-making and/or provide insights into its behavior.

### 18.11) Analysis System Output

Analysis System Output 1850 may generate a report and/or provide another form of output to one or more users and/or systems. It may provide explainable outputs to describe the model's decision-making. It may make RL systems' decisions more understandable and/or relatable to operators.

### 19) Functional Diagram of Analysis System Predicting Model Degradation

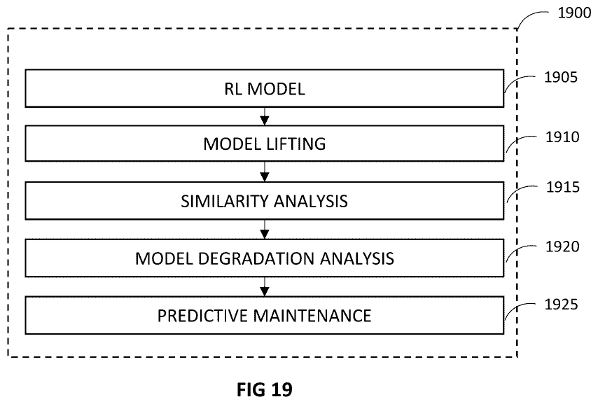

FIG. 19 depicts an example of an Analysis System 1900 used to detect model degradation. Model degradation may be a decline in performance, accuracy, and/or robustness, etc. caused by changes in, for example but not limited to, the underlying data and/or environment, etc. This example uses an Analysis System 1900 to detect and/or mitigate model degradation. This process may be reordered. It may include other steps not included in this figure and/or steps may be removed in other examples.

### 19.1) Analysis System

In this example, an Analysis System 1900 may be used to detect potential model degradation of an RL Model 1905. It may include, but is not limited to, a decrease in accuracy, robustness, explainability, and/or interpretability. It may predict degradation before it occurs.

### 19.2) RL Model

In this example, a RL Model 1905 may be used as input to an Analysis System 1900. It may utilize but is not limited to processes similar to those described in FIG. 17 and FIG. 18. Input to Model Lifting 1910 may be continuous data extracted from an instrumented model.

### 19.3) Model Lifting

In this example, a Model Lifting 1910 module may lift the RL Model 1905 to an intermediate representation that is optimal for analysis.

### 19.4) Similarity Analysis

In this example, a Similarity Analysis 1915 module may be used in this context to find similar models that had degradation and/or that align with the behavior of the provided RL Model 1905.

### 19.5) Model Degradation Analysis

Model Degradation Analysis 1920 may determine how an RL Model 1905 performance degrades over time. It may take into account one or more factors, such as but not limited to analyzing the RL Model 1905 itself like high variance, over-estimation, and/or inefficiency. It may take into account Similarity Analysis 1915 results. It may utilize counterfactual explanations.

### 19.6) Predictive Maintenance

Predictive Maintenance 1925 may determine when an RL Model 1905 is likely to fail and/or experience lower accuracy. It may predict when in the future it may degrade. It may incorporate predictive models and/or algorithms, etc.

### 20) Functional Diagram for AI Artifact Marketplace UI/UX Example

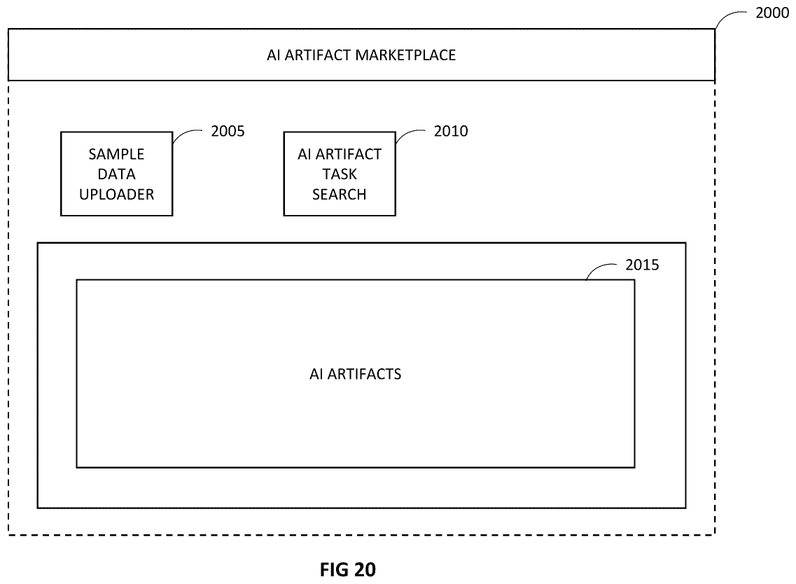

FIG. 20 depicts an example of a User Interface 2000 for an analysis system used as an AI artifact marketplace. It may include other modules not included in this figure and/or steps may be removed in other examples.

### 20.1) User Interface

In this example, a User Interface 2000 may be used but is not limited to perform searches to find specific models. For example, it may be used to find but is not limited to vulnerable models to avoid, and/or high-performing models. A user and/or system may use sample data and/or a task to find one or more relevant models.

### 20.2) Sample Data Uploader

A Sample Data Uploader 2005 may be used to provide sample data to perform searches within an AI Artifact marketplace to find and/or query artifacts that relate to the data provided. A user and/or system may upload and/or provide sample data, such as, but not limited to, text, image, video, and/or audio data, etc. It may provide metrics such as, but is not limited to, accuracy, robustness, explainability, and/or interpretability.

### 20.3) AI Artifact Task Search

An AI Artifact Task Search 2010 may be a mechanism for searching the model marketplace. It may enable searching for specific tasks, such as, but not limited to, object detection, image classification, sentiment analysis, and/or speech recognition, etc.

### 20.4) AI Artifacts

An AI Artifacts 2015 section may display one or more artifacts. It may correlate to, but is not limited to, data provided in a Sample Data Uploader and/or a task provided in an AI Artifact Task Search 2010. It may provide all artifacts. It may be paginated, have infinite scrolling, and/or a next/previous button, etc. Artifacts in this section may have information provided with them, such as but not limited to metadata, links, scores, reports, and/or download buttons, etc.

### 21) Functional Diagram for Model Historical Analysis Visualization UI/UX Example

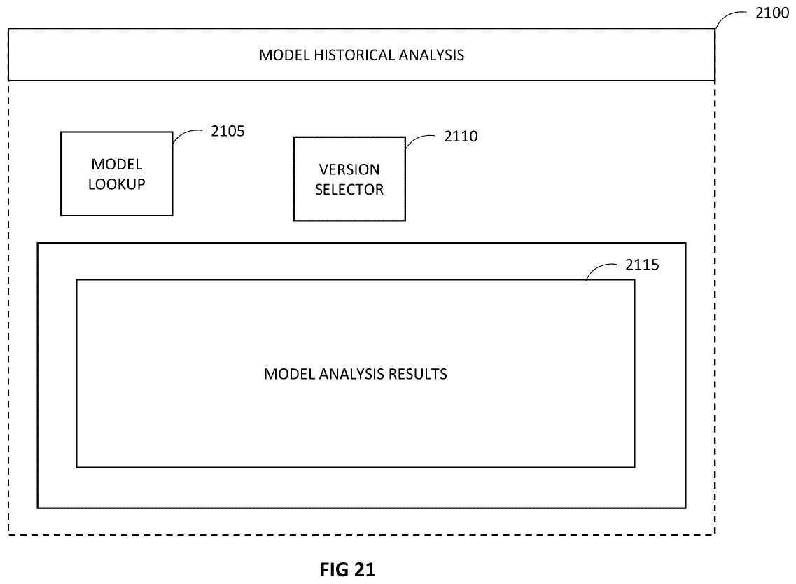

FIG. 21 depicts an example of a User Interface 2100 for an analysis system used for visualizing the history of a model. It may include other modules not included in this figure and/or steps may be removed in other examples.

### 21.1) User Interface

In this example, a User Interface 2100 may be used to track and/or provide information on versions of a model. It may include one or more versions of a model and/or one or more forks of a model.

### 21.2) Model Lookup

A Model Lookup 2105 button may be used to select a specific model and/or family of models to visualize its versions in the user interface.

### 21.3) Version Selector

In this example, a specific version may be selected from a Version Selector 2110 to visualize specific information about the version. For example, it may show but is not limited to graphs, charts, and/or metrics, etc.

### 21.4) Model Analysis Results

In this section of the user interface, Model Analysis Results 2115 may display information about a version. It may utilize information selected from a Model Lookup 2105 and/or a Version Selector 2110.

### 22) Functional Diagram for Model Training Simulator Visualization UI/UX Example

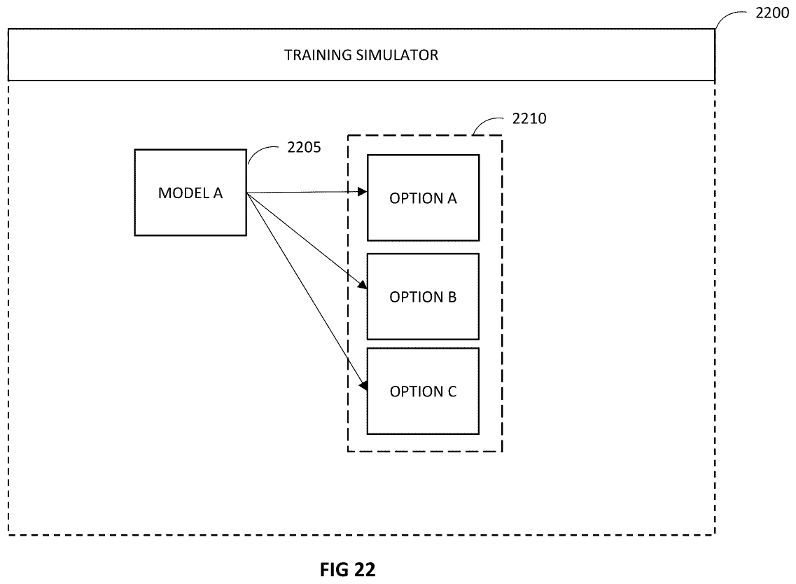

FIG. 22 depicts an example of a User Interface 2200 for an analysis system used to simulate training of one or more models. It may include other modules not included in this figure and/or steps may be removed in other examples.

### 22.1) User Interface

In this example, a User Interface 2200 may be used to simulate training of one or more models. The results of these simulations may be displayed in the user interface.

### 22.2) Model A

Model A 2205 may be the original model being fine-tuned from. It may be provided by but is not limited to a user. It may be trained by a User Interface 2200. It may be retrieved from but is not limited to an online source, and/or proprietary source, etc.

### 22.3) Model Options

Model Options 2210 may be used to simulate training of one or more models. This may be but is not limited to training multiple AI models for a short period of time and determining which are most important to continue training of. It may be training multiple models with different AI Artifacts and determining which trained models have, for example but not limited to, the most secure supply chain. The results of these simulations may be displayed in the user interface.

What is claimed is:

1. A method for analyzing at least one computing system for supply chain vulnerabilities of at least one machine learning model comprised in the at least one computing system, the method comprising:
configuring, via a processor, at least one machine learning model and optionally additional data, wherein the additional data comprises information that pertains to and correlates with the machine learning model, from a data storage, a memory, or via a communication, or via a user entry through a user interface, for the at least one machine learning model;
decomposing, via the processor, operations of the at least one machine learning model's computational graph into smaller decomposed components of operations;
associating, via the processor, properties of each decomposed component with properties of the original operations and, when available, associating additional data,
detecting, via the processor, the semantic similarity of at least one decomposed component and at least one previously encountered decomposed component;
converting, via the processor, at least one decomposed component into a standardized representation;
calculating, via the processor, at least one signature of at least one decomposed component comprising at least one machine learning model;
evaluating, via the processor, whether portions of the at least one machine learning model are similar to at least one previously calculated signature;
testing, via the processor, for supply chain and model vulnerabilities that exist based on previous analyzed identical or similar signatures;
identifying, via the processor, the one or more vulnerabilities that persist and the defenses that resulted in the greatest increase in performance, robustness, explainability, or fairness on machine learning models with the identical or similar signatures;
storing, via the processor, the generated signatures, identified vulnerabilities, and identified defenses, pertaining to at least one input in the memory; and
generating, via the processor, at least one report detailing the machine learning model's supply chain, vulnerabilities, and defenses.

2. The method according to claim 1, wherein the at least one computing system comprises at least one of an artificial intelligence system, embedded device, tablet device, industrial control system, operational technology, information technology device, or mobile device.

3. The method according to claim 1, wherein the at least one machine learning model comprises at least one of supervised learning, unsupervised learning, reinforcement learning, self-supervised learning, or semi-supervised learning, and may be converted to an intermediate representation such as Open Neural Network Exchange (ONNX), Multi-Level Intermediate Representation (MLIR), Intermediate Representation Execution Environment (IREE), or a custom intermediate representation.

4. The method according to claim 1, wherein the at least one additional data comprises at least one artificial intelligence model, training dataset, testing dataset, validation dataset, configuration file, source code, weights file, binary, library, package, manifest file, compiler, disassembled file, decompiled file, URL, API endpoint, or performance results, and provided over at least one AIOps pipeline, MLOps pipeline, CI/CD pipeline, DevSecOps pipeline, API, CLI, user interface, virtual machine, Docker container, storage device, or transfer protocol, or the at least one input data comprises being retrieved by at least one of scanning a file system, scraping one or more websites, iterating through the versions or commits of a code repository, or scanning a network.

5. The method according to claim 1, wherein configuring comprises sending data a machine learning model and additional data through a graphical user interface (GUI), application programming interface (API), command line interface (CLI), through a storage device, protocols such as FTP, SSH, SCP, scraping data from open-source or closed-source repositories, scanning or extracting data on at least one computing system, or over a network, or providing supplementary data through a user interface or API.

6. The method according to claim 1, wherein decomposing comprises separating layers, neurons, layer modules, gradients, activation functions, operations, inputs, input shapes, output shapes, gradients, edges, or outputs, or through data passed through the full model or instrumented layers or operators, or a combination, into decomposed components.

7. The method according to claim 1, wherein associating comprises matching layers, neurons, layer modules, gradients, activation functions, operations, inputs, input shapes, output shapes, gradients, edges, or outputs, or through data passed through the full model or instrumented layers or operators, or a combination, with decomposed components, or summarizing, such as through an algorithmic- or AI-based mechanism, the behavior or objective of a series of operations in a decomposed component.

8. The method according to claim 1, wherein detecting semantic similarity comprises analyzing objectives, input shapes, output shapes, properties, gradients, activation functions, operator names, layer names, or property names of decomposed components, and matching them using a lookup table, database of operators, or using similarity algorithms like Jaccard Index, Cosine Similarity, Manhattan Distance, Euclidean Distance, Dice Similarity, Hamming Distance, or using deep learning models such as transformer-based models, contrastive learning models, and graph-based similarity measures.

9. The method according to claim 1, wherein converting comprises lifting decomposed components into an intermediate representation, changing operations from one format to another, such as a different AI framework, converting a subsection of operations, converting operations randomly, converting operations at fixed intervals, and compiling operations.

10. The method according to claim 1, wherein the at least one signature calculated is based on at least one of the model architecture, weights, intermediate representation, configurations, hyperparameters, performance, accuracy, robustness, security, activations, or conductance, and generating a signature by generating a vector representation or a hash of one or more feature of the model or a portion of it by calculating what features are most critical to the model, calculating the quality of training of each layer of the model, calculating a compressed version of the weights of a model, determining the layer-wise contribution of each subset of layers in a model to overall performance metrics like accuracy, robustness, sensitivity, and loss reduction, calculating vectors of key weights, activation functions, and layer or operator sequences, calculating how quantizing weights and activations affects overall model performance, calculating the relationship between adversarial examples and class boundaries, calculated based on conductance results such that statistical measurement of every token of the input to the model and every token of the output from the model are correlated numerically, or calculating summaries of parameters and neural network architectures that can be represented as signatures.

11. The method according to claim 1, wherein the evaluation of whether portions of the at least one machine learning model are similar to at least one previously analyzed signature comprises determining if one signature is identical or is most similar to one or more previous signatures from models, determining which prior models have the most similar or identical signatures, performing similarity comparisons such as evaluating using at least one of Euclidean distance, Hamming distance, Dice-Sørensen coefficient, Manhattan distance, Minkowski distance, Cosine similarity, Jaccard Index, chi-square, Canberra distance, Chebyshev distance, similarity model, or a machine learning model, evaluating dynamically how models perform under analysis while provided the same data for inference, predicting similarity of models based on smaller representations of models, comparing predictions and confidence of outputs given a series of inputs, or using a Graph Neural Network to compare graphs representing a model's architecture and weights.

12. The method according to claim 1, wherein the testing of at least one vulnerability comprises a supply chain attack, transferability attack, poisoning attack, backdoor attack, evasion attack, inversion attack, software vulnerability, or malware, and may comprise other issues such as low accuracy, performance bottlenecks, imbalanced inference, or high sensitivity, or may include implementing identified defenses and generated guidance on steps to remediate identified vulnerabilities comprises a list of steps to remediate the issue, a new dataset, a description of specific data to remove from or add to a dataset during retraining or fine-tuning, new data to fine-tune the model with, a new model that does not contain the vulnerability, a different software package version to use, a list of safer models to use or train from, or preventing the vulnerable machine learning model from being used in future projects.

13. The method according to claim 1, wherein storing of data comprises at least one vector database, graph database, time-series database, key-value database, network database, object-oriented database, or NoSQL database, and may cluster signatures or version them such as by similarity score, when they were developed, who developed them, where they were developed, or by risk score, and may include stored signatures comprise at least one of vulnerabilities, weaknesses, risks, authors, architectures, machine learning model types, performance scores, scorecards, lineage, configurations, or timestamps.

14. The method according to claim 1, wherein a report may comprise a risk score comprises at least one of the amount vulnerabilities found, severity of vulnerabilities found, vulnerabilities in the lineage of at least one input, or trustworthiness of organizations or users in the lineage of at least one input.

15. The method according to claim 1, wherein the report comprises at least one of an analysis report, user-readable analysis report, bill of materials, visualizations, suggestions, texts, notifications, emails, summaries, recommendations, scorecard, machine-readable analysis report, or API call.

16. The method according to claim 1, wherein the machine learning model is instrumented to analyze at least one of the model, its inputs, its outputs, intermediate neurons, or intermediate layers for at least one of explainability, performance, or vulnerabilities.

17. The method according to claim 16, wherein the instrumentation is of the compilation process to analyze at least one of the compiler or compiled binary.

18. The method according to claim 1, wherein the at least one signature that is stored is used to reconstruct at least one input data.

19. The method according to claim 1, wherein the stored data signatures are used for at least one of identifying use cases related to at least one input data, machine learning models for a task, most similar models, or most similar performing models.

20. The method according to claim 1, wherein the at least one input data is migrated to the format of at least one other input data stored in a data store.

21. A system for analyzing at least one computing system for supply chain vulnerabilities of at least one machine learning model comprised in the at least one computing system, the system comprising:
a processor; and
a memory storing a computer-executable program,
wherein when the computer-executable program is executed by the processor, the computer-executable program configures the processor to:
configure at least one machine learning model and optionally additional data, wherein the additional data comprises information that pertains to and correlates with the machine learning model, from a data storage, the memory, or via a communication, or via a user entry through a user interface, for the at least one machine learning model;
decompose operations of the at least one machine learning model's computational graph into smaller decomposed components of operations;
associate properties of each decomposed component with properties of the original operations and, when available, associating additional data,
detect the semantic similarity of at least one decomposed component and at least one previously encountered decomposed component;
convert at least one decomposed component into a standardized representation;
calculate at least one signature of at least one decomposed component comprising at least one machine learning model;
evaluate whether portions of the at least one machine learning model are similar to at least one previously calculated signature;
test for supply chain and model vulnerabilities that exist based on previous analyzed identical or similar signatures;
identify the one or more vulnerabilities that persist and the defenses that resulted in the greatest increase in performance, robustness, explainability, or fairness on machine learning models with the identical or similar signatures;
store the generated signatures, identified vulnerabilities, and identified defenses, pertaining to at least one input in the memory; and
generate at least one report detailing the machine learning model's supply chain, vulnerabilities, and defenses.

22. The system according to claim 21, wherein the at least one computing system comprises at least one of an artificial intelligence system, embedded device, tablet device, industrial control system, operational technology, information technology device, or mobile device.

23. The system according to claim 21, wherein the at least one machine learning model comprises at least one of supervised learning, unsupervised learning, reinforcement learning, self-supervised learning, or semi-supervised learning, and may be converted to an intermediate representation such as Open Neural Network Exchange (ONNX), Multi-Level Intermediate Representation (MLIR), Intermediate Representation Execution Environment (IREE), or a custom intermediate representation.

24. The system according to claim 21, wherein the at least one additional data comprises at least one artificial intelligence model, training dataset, testing dataset, validation dataset, configuration file, source code, weights file, binary, library, package, manifest file, compiler, disassembled file, decompiled file, URL, API endpoint, or performance results, and provided over at least one AIOps pipeline, MLOps pipeline, CI/CD pipeline, DevSecOps pipeline, API, CLI, user interface, virtual machine, Docker container, storage device, or transfer protocol, or the at least one input data comprises being retrieved by at least one of scanning a file system, scraping one or more websites, iterating through the versions or commits of a code repository, or scanning a network.

25. The system according to claim 21, wherein configuring comprises sending data a machine learning model and additional data through a graphical user interface (GUI), application programming interface (API), command line interface (CLI), through a storage device, protocols such as FTP, SSH, SCP, scraping data from open-source or closed-source repositories, scanning or extracting data on at least one computing system, or over a network, or providing supplementary data through a user interface or API.

26. The system according to claim 21, wherein decomposing comprises separating layers, neurons, layer modules, gradients, activation functions, operations, inputs, input shapes, output shapes, gradients, edges, or outputs, or through data passed through the full model or instrumented layers or operators, or a combination, into decomposed components.

27. The system according to claim 21, wherein associating comprises matching layers, neurons, layer modules, gradients, activation functions, operations, inputs, input shapes, output shapes, gradients, edges, or outputs, or through data passed through the full model or instrumented layers or operators, or a combination, with decomposed components, or summarizing, such as through an algorithmic- or AI-based mechanism, the behavior or objective of a series of operations in a decomposed component.

28. The system according to claim 21, wherein detecting semantic similarity comprises analyzing objectives, input shapes, output shapes, properties, gradients, activation functions, operator names, layer names, or property names of decomposed components, and matching them using a lookup table, database of operators, or using similarity algorithms like Jaccard Index, Cosine Similarity, Manhattan Distance, Euclidean Distance, Dice Similarity, Hamming Distance, or using deep learning models such as transformer-based models, contrastive learning models, and graph-based similarity measures.

29. The system according to claim 21, wherein converting comprises lifting decomposed components into an intermediate representation, changing operations from one format to another, such as a different AI framework, converting a subsection of operations, converting operations randomly, converting operations at fixed intervals, and compiling operations.

30. The system according to claim 21, wherein the at least one signature calculated is based on at least one of the model architecture, weights, intermediate representation, configurations, hyperparameters, performance, accuracy, robustness, security, activations, or conductance, and generating a signature by generating a vector representation or a hash of one or more feature of the model or a portion of it by calculating what features are most critical to the model, calculating the quality of training of each layer of the model, calculating a compressed version of the weights of a model, determining the layer-wise contribution of each subset of layers in a model to overall performance metrics like accuracy, robustness, sensitivity, and loss reduction, calculating vectors of key weights, activation functions, and layer or operator sequences, calculating how quantizing weights and activations affects overall model performance, calculating the relationship between adversarial examples and class boundaries, calculated based on conductance results such that statistical measurement of every token of the input to the model and every token of the output from the model are correlated numerically, or calculating summaries of parameters and neural network architectures that can be represented as signatures.

31. The system according to claim 21, wherein the evaluation of whether portions of the at least one machine learning model are similar to at least one previously analyzed signature comprises determining if one signature is identical or is most similar to one or more previous signatures from models, determining which prior models have the most similar or identical signatures, performing similarity comparisons such as evaluating using at least one of Euclidean distance, Hamming distance, Dice-Sørensen coefficient, Manhattan distance, Minkowski distance, Cosine similarity, Jaccard Index, chi-square, Canberra distance, Chebyshev distance, similarity model, or a machine learning model, evaluating dynamically how models perform under analysis while provided the same data for inference, predicting similarity of models based on smaller representations of models, comparing predictions and confidence of outputs given a series of inputs, or using a Graph Neural Network to compare graphs representing a model's architecture and weights.

32. The system according to claim 21, wherein the testing of at least one vulnerability comprises a supply chain attack, transferability attack, poisoning attack, backdoor attack, evasion attack, inversion attack, software vulnerability, or malware, and may comprise other issues such as low accuracy, performance bottlenecks, imbalanced inference, or high sensitivity, or may include implementing identified defenses and generated guidance on steps to remediate identified vulnerabilities comprises a list of steps to remediate the issue, a new dataset, a description of specific data to remove from or add to a dataset during retraining or fine-tuning, new data to fine-tune the model with, a new model that does not contain the vulnerability, a different software package version to use, a list of safer models to use or train from, or preventing the vulnerable machine learning model from being used in future projects.

33. The system according to claim 21, wherein storing of data comprises at least one vector database, graph database, time-series database, key-value database, network database, object-oriented database, or NoSQL database, and may cluster signatures or version them such as by similarity score, when they were developed, who developed them, where they were developed, or by risk score, and may include stored signatures comprise at least one of vulnerabilities, weaknesses, risks, authors, architectures, machine learning model types, performance scores, scorecards, lineage, configurations, or timestamps.

34. The system according to claim 21, wherein a report may comprise a risk score comprises at least one of the amount vulnerabilities found, severity of vulnerabilities found, vulnerabilities in the lineage of at least one input, or trustworthiness of organizations or users in the lineage of at least one input.

35. The system according to claim 21, wherein the report comprises at least one of an analysis report, user-readable analysis report, bill of materials, visualizations, suggestions, texts, notifications, emails, summaries, recommendations, scorecard, machine-readable analysis report, or API call.

36. The system according to claim 21, wherein the machine learning model is instrumented to analyze at least one of the model, its inputs, its outputs, intermediate neurons, or intermediate layers for at least one of explainability, performance, or vulnerabilities.

37. The system according to claim 36, wherein the instrumentation is of the compilation process to analyze at least one of the compiler or compiled binary.

38. The system according to claim 21, wherein the at least one signature that is stored is used to reconstruct at least one input data.

39. The system according to claim 21, wherein the stored data signatures are used for at least one of identifying use cases related to at least one input data, machine learning models for a task, most similar models, or most similar performing models.

40. The system according to claim 21, wherein the at least one input data is migrated to the format of at least one other input data stored in a data store.
